(19) United States
(12) Patent Application Publication
(10) Pub. No.: US 2024/0067330 A1
(43) Pub. Date: Feb. 29, 2024

(54) COMBINED CYCLIC AND TEETER SYSTEM FOR AN EVTOL AIRCRAFT

(71) Applicant: BETA AIR, LLC, South Burlington, VT (US)

(72) Inventors: Kyle Brookes, SOUTH BURLINGTON, VT (US); Sebastian Perron, SOUTH BURLINGTON, VT (US)

(73) Assignee: BETA AIR, LLC, SOUTH BURLINGTON, VT (US)

(21) Appl. No.: 18/096,931

(22) Filed: Jan. 13, 2023

Related U.S. Application Data
(63) Continuation-in-part of application No. 17/966,804, filed on Oct. 15, 2022.
Application No. 17/966,804 is a continuation-in-part of application No. 17/852,229, filed on Jun. 28, 2022, now Pat. No. 11,643,196.

(51) Int. Cl. B64C 19/00; B64C 29/00

(52) U.S. Cl. CPC B64C 19/00; B64C 29/0025

(57) ABSTRACT

A combined cyclic and teeter system for an electric vertical takeoff and landing (eVTOL) aircraft is disclosed. In some embodiments, the eVTOL aircraft may include a motor and a propulsor driven by the motor, wherein the propulsor may include a propeller with a rigid blade and configured to propel the eVTOL aircraft. In some embodiments, the eVTOL aircraft may include a cyclic attached to the propeller and configured to change a pitch of blades of the propeller. In some embodiments, the eVTOL aircraft may include a passive flap attached to the propeller and configured to passively control flight transients, wherein the passive flap may include a base rotatably affixed to the propulsor and configured to rotate about a rotational axis and a hinge connecting the base and the propeller and configured to allow the propeller to pivot about a pivot point of the hinge.

### CROSS-REFERENCE TO RELATED APPLICATIONS

This application is a continuation-in-part of U.S. patent application Ser. No. 17/966,804, filed on Oct. 15, 2022, entitled “A SYSTEM AND METHOD FOR PROPULSOR CYCLIC CONTROL ON AN ELECTRIC AIRCRAFT,” and U.S. patent application Ser. No. 17/852,229, filed on Jun. 28, 2022, entitled “TEETERING PROPULSOR ASSEMBLY OF AN ELECTRIC VERTICAL TAKEOFF AND LANDING AIRCRAFT.” Each of U.S. patent application Ser. No. 17/966,804, and U.S. patent application Ser. No. 17/852,229 are incorporated by reference herein in its entirety.

### FIELD OF THE INVENTION

The present invention generally relates to the field of aircraft. In particular, the present invention is directed to a system and method for a combined cyclic and teeter system for an eVTOL aircraft.

### BACKGROUND

Edgewise flight can cause non-axial strain on rotors and corresponding drive systems of an aircraft. Such strain results in expediated aging and wear of drive systems. Existing solutions to this problem are not sufficient.

### SUMMARY OF THE DISCLOSURE

In an aspect, a combined cyclic and teeter system for an electric vertical takeoff and landing (eVTOL) aircraft is disclosed. In some embodiments, the system may include an eVTOL aircraft. In some embodiments, the eVTOL aircraft may include a motor and a propulsor driven by the motor, wherein the propulsor may include a propeller with a rigid blade and configured to propel the eVTOL aircraft. In some embodiments, the eVTOL aircraft may include a cyclic attached to the propeller and configured to change a pitch of blades of the propeller. In some embodiments, the eVTOL aircraft may include a passive flap attached to the propeller and configured to passively control flight transients, wherein the passive flap may include a base rotatably affixed to the propulsor and configured to rotate about a rotational axis and a hinge connecting the base and the propeller and configured to allow the propeller to pivot about a pivot point of the hinge.

In another aspect, a method of a combined cyclic and teeter system of an electric vertical takeoff and landing aircraft is disclosed. In some embodiments, the method may include obtaining an eVTOL aircraft. In some embodiments, the method may include receiving a motor. In some embodiments, the method may include receiving a propeller of a propulsor with a rigid blade. In some embodiments, the method may include connecting, using a hinge of the passive flap, the base and the propeller. In some embodiments, the method may include attaching a cyclic to the propeller. In some embodiments, the method may include propelling, using a propulsor driven by the motor, an eVTOL aircraft. In some embodiments, the method may include rotating the base of the passive flap about a rotational axis. In some embodiments, the method may include changing, using a cyclic, a pitch of blades of the propeller. In some embodiments, the method may include allowing, using the hinge of the passive flap, the propeller to pivot about a pivot point of the hinge. In some embodiments, the method may include passively controlling, using the passive flap attached to the propulsor, flight transients. In some embodiments, the flight transients may include wind gusts.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is an illustration of an exemplary aircraft in one or more aspects of the present disclosure;

FIG. 2 is a block diagram of a system for propulsor cyclic control on an electric aircraft;

FIG. 3 is a schematic diagram illustrating an exemplary teetering propulsor assembly of an electric aircraft in accordance with one or more embodiments of the present disclosure;

FIGS. 4A-B are a set of schematic diagrams illustrating an exemplary movement of teetering propulsor assembly in accordance with one or more embodiments of the present disclosure;

FIG. 5 is an illustration showing an exploded view of an exemplary embodiment of a cyclic and a passive flap combined for an eVTOL aircraft;

FIG. 6 is an exemplary embodiment of a propulsor assembly;

FIGS. 7A-B are illustrations showing cross-sectional views of an exemplary embodiment of a rotor for an electric aircraft motor in one or more aspects of the present disclosure;

FIG. 8 is a block diagram of an exemplary flight controller;

FIG. 9 is a flow diagram of method for a combined cyclic and teeter system for an eVTOL aircraft; and

FIG. 10 is a block diagram of a computing system that can be used to implement any one or more of the methodologies disclosed herein and any one or more portions thereof. The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

At a high level, aspects of the present disclosure may be used to mitigate forces from edgewise flight on an aircraft. Often times, propulsors are subjected to tremendous shear forces and loads due to external conditions such as wind. To mitigate those forces, a combined cyclic and teeter system may be used.

In the following description, for the purposes of explanation, numerous specific details are set forth in order to provide a thorough understanding of the present invention. It will be apparent, however, that the present invention may be practiced without these specific details. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply embodiments of the inventive concepts defined in the appended claims. Hence, specific dimensions and other physical characteristics relating to the embodiments disclosed herein are not to be considered as limiting, unless the claims expressly state otherwise.

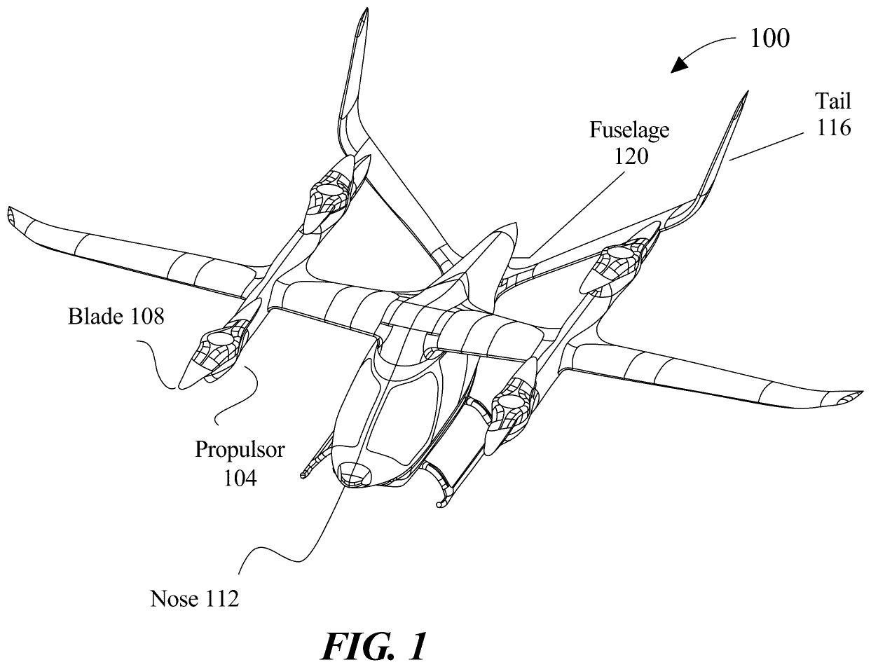

For purposes of description in this disclosure, the terms “up”, “down”, “forward”, “horizontal”, “left”, “right”, “above”, “below”, “beneath”, and derivatives thereof shall relate to the invention as oriented in FIG. 1. Furthermore, there is no intention to be bound by any expressed or implied theory presented in the preceding technical field, background, brief summary, or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed in this disclosure are not to be considered as limiting, unless the claims expressly state otherwise.

Referring now to FIG. 1, an exemplary embodiment of an electric aircraft 100 with a propulsor 104 is illustrated in accordance with one or more embodiments of the present disclosure. As used in this disclosure an “aircraft” is any vehicle that may fly by gaining support from the air. As a non-limiting example, aircraft may include airplanes, helicopters, commercial and/or recreational aircrafts, instrument flight aircrafts, drones, electric aircrafts, airliners, rotorcrafts, vertical takeoff and landing aircrafts, jets, airships, blimps, gliders, paramotors, and the like. Aircraft 100 may include an electrically powered aircraft. In embodiments, electrically powered aircraft may be an electric vertical takeoff and landing (eVTOL) aircraft. Electric aircraft may be capable of rotor-based cruising flight, rotor-based takeoff, rotor-based landing, fixed-wing cruising flight, airplane-style takeoff, airplane-style landing, and/or any combination thereof. Electric aircraft may include one or more manned and/or unmanned aircrafts. Electric aircraft may include one or more all-electric short takeoff and landing (eSTOL) aircrafts. For example, and without limitation, eVTOL aircrafts may accelerate plane to a flight speed on takeoff and decelerate plane after landing. In an embodiment, and without limitation, electric aircraft may be configured with an electric propulsion assembly. Electric propulsion assembly may include any electric propulsion assembly as described in U.S. Nonprovisional application Ser. No. 16/603,225, filed on Dec. 4, 2019, and entitled “AN INTEGRATED ELECTRIC PROPULSION ASSEMBLY,” the entirety of which is incorporated herein by reference.

Still referring to FIG. 1, and as used in this disclosure, a “vertical take-off and landing (eVTOL) aircraft” is an aircraft that can hover, take off, and land vertically. In some embodiments, the eVTOL aircraft may use an energy source of a plurality of energy sources to power aircraft. To optimize the power and energy necessary to propel aircraft 100, eVTOL may be capable of rotor-based cruising flight, rotor-based takeoff, rotor-based landing, fixed-wing cruising flight, airplane-style takeoff, airplane style landing, and/or any combination thereof. Rotor-based flight, as described herein, is where the aircraft generates lift and propulsion by way of one or more powered rotors or blades coupled with an engine, such as a “quad-copter,” multi-rotor helicopter, or other vehicle that maintains its lift primarily using downward thrusting propulsors. “Fixed-wing flight”, as described herein, is where an aircraft is capable of flight using wings and/or foils that generate lift caused by the aircraft's forward airspeed and the shape of the wings and/or foils, such as airplane-style flight.

Still referring to FIG. 1, and in one or more embodiments, aircraft 100 may include motor, which may be mounted on a structural feature of an aircraft. Design of motor may enable it to be installed external to the structural member (such as a boom, nacelle, or fuselage) for easy maintenance access and to minimize accessibility requirements for the structure. This may improve structural efficiency by requiring fewer large holes in the mounting area. This design may include two main holes in the top and bottom of the mounting area to access bearing cartridge. Further, a structural feature may include a component of aircraft 100. For example, and without limitation structural feature may be any portion of a vehicle incorporating motor, including any vehicle as described below. As a further non-limiting example, a structural feature may include without limitation a wing, a spar, an outrigger, a fuselage, or any portion thereof; persons skilled in the art, upon reviewing the entirety of this disclosure, will be aware of many possible features that may function as at least a structural feature. At least a structural feature may be constructed of any suitable material or combination of materials, including without limitation metal such as aluminum, titanium, steel, or the like, polymer materials or composites, fiberglass, carbon fiber, wood, or any other suitable material. As a non-limiting example, at least a structural feature may be constructed from additively manufactured polymer material with a carbon fiber exterior; aluminum parts or other elements may be enclosed for structural strength, or for purposes of supporting, for instance, vibration, torque or shear stresses imposed by at least propulsor 104. Persons skilled in the art, upon reviewing the entirety of this disclosure, will be aware of various materials, combinations of materials, and/or constructions techniques.

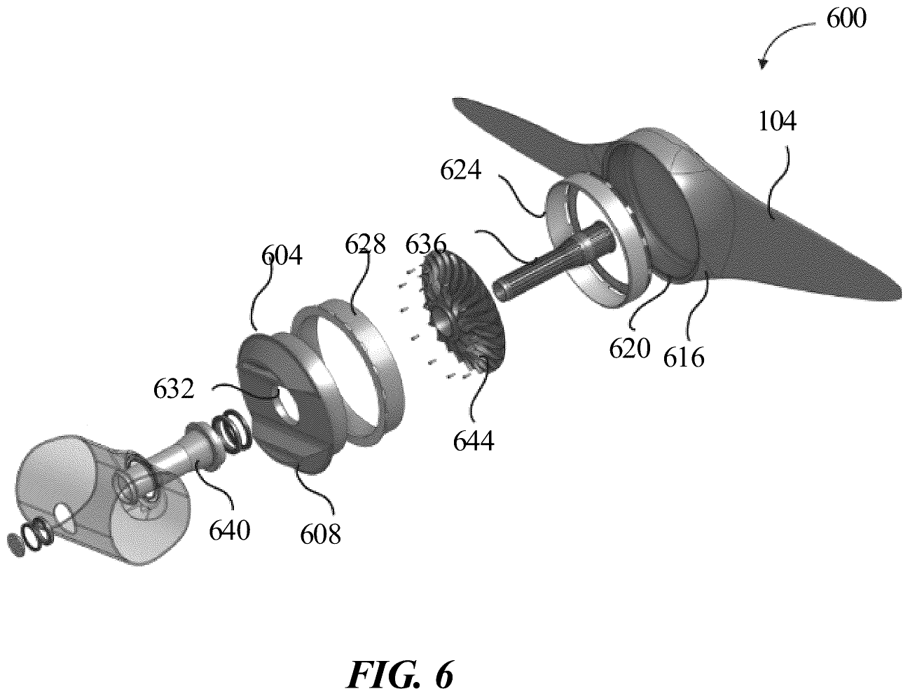

Still referring to FIG. 1, aircraft 100 may include a propulsor 104. For the purposes of this disclosure, a “propulsor” is a component or device used to propel a craft by exerting force on a fluid medium, which may include a gaseous medium such as air or a liquid medium such as water. Propulsor may include any device or component that consumes electrical power on demand to propel an electric aircraft in a direction or other vehicle while on ground or in-flight. For example, and without limitation, propulsor may include a rotor, propeller, paddle wheel, and the like thereof. In an embodiment, propulsor may include a plurality of blades. As used in this disclosure a “blade” is a propeller that converts rotary motion from an engine or other power source into a swirling slipstream. In an embodiment, blade may convert rotary motion to push the propeller forwards or backwards. In an embodiment, propulsor may include a rotating power-driven hub, to which are attached several radial airfoil-section blades such that the whole assembly rotates about a longitudinal axis. In one or more embodiments, a rotor may be used in a motor of a lift propulsor, which is further described in this disclosure with reference to FIG. 6. For the purposes of this disclosure, a “lift propulsor” is a propulsor that produces lift. In one or more exemplary embodiments, propulsor 104 may include a vertical propulsor or a forward propulsor. A forward propulsor may include a propulsor configured to propel aircraft 100 in a forward direction. A vertical propulsor may include a propulsor configured to propel aircraft 100 in an upward direction. One of ordinary skill in the art would understand upward to comprise the imaginary axis protruding from the earth at a normal angle, configured to be normal to any tangent plane to a point on a sphere (i.e. skyward). In an embodiment, vertical propulsor can be a propulsor that generates a substantially downward thrust, tending to propel an aircraft in an opposite, vertical direction and provides thrust for maneuvers. Such maneuvers can include, without limitation, vertical take-off, vertical landing, hovering, and/or rotor-based flight such as “quadcopter” or similar styles of flight.

Still referring to FIG. 1, and in an embodiment, propulsor 104 may include a propeller, a blade, or the like. The function of a propeller is to convert rotary motion from an engine or other power source into a swirling slipstream which pushes the propeller forwards or backwards. The propulsor may include a rotating power-driven hub, to which are attached several radial airfoil-section blades such that the whole assembly rotates about a longitudinal axis. The blade pitch of a propeller may, for example, be fixed, manually variable to a few set positions, automatically variable (e.g. a “constant-speed” type), or any combination thereof. In an exemplary embodiment, propellers for an aircraft may be designed to be fixed to their hub at an angle similar to the thread on a screw makes an angle to the shaft; this angle may be referred to as a pitch or pitch angle which will determine the speed of the forward movement as the blade rotates.

Still referring to FIG. 1, and in an embodiment, a propulsor can include a thrust element which may be integrated into the propulsor. The thrust element may include, without limitation, a device using moving or rotating foils, such as one or more rotors, an airscrew or propeller, a set of airscrews or propellers such as contra-rotating propellers, a moving or flapping wing, or the like. Further, a thrust element, for example, can include without limitation a marine propeller or screw, an impeller, a turbine, a pump-jet, a paddle or paddle-based device, or the like.

Still referring to FIG. 1, a propulsor may include a pusher component. As used in this disclosure a “pusher component” is a component that pushes and/or thrusts an aircraft through a medium. As a non-limiting example, pusher component may include a pusher propeller, a paddle wheel, a pusher motor, a pusher propulsor, and the like. Pusher component may be configured to produce a forward thrust. As used in this disclosure a “forward thrust” is a thrust that forces aircraft through a medium in a horizontal direction, wherein a horizontal direction is a direction parallel to the longitudinal axis. For example, forward thrust may include a force of 1145 N to force aircraft to in a horizontal direction along the longitudinal axis. As a further non-limiting example, pusher component may twist and/or rotate to pull air behind it and, at the same time, push aircraft 100 forward with an equal amount of force. In an embodiment, and without limitation, the more air forced behind aircraft, the greater the thrust force with which aircraft 100 is pushed horizontally will be. In another embodiment, and without limitation, forward thrust may force aircraft 100 through the medium of relative air. Additionally or alternatively, plurality of propulsor may include one or more puller components. As used in this disclosure a “puller component” is a component that pulls and/or tows an aircraft through a medium. As a non-limiting example, puller component may include a flight component such as a puller propeller, a puller motor, a tractor propeller, a puller propulsor, and the like. Additionally, or alternatively, puller component may include a plurality of puller flight components.

Still referring to FIG. 1, and in one or more embodiments, propulsor 104 includes a motor. The motor may include, without limitation, any electric motor, where an electric motor is a device that converts electrical energy into mechanical energy, for instance by causing a shaft to rotate. A motor may be driven by direct current (DC) electric power; for instance, a motor may include a brushed DC motor or the like. A motor may be driven by electric power having varying or reversing voltage levels, such as alternating current (AC) power as produced by an alternating current generator and/or inverter, or otherwise varying power, such as produced by a switching power source. A motor may include, without limitation, a brushless DC electric motor, a permanent magnet synchronous motor, a switched reluctance motor, and/or an induction motor; persons skilled in the art, upon reviewing the entirety of this disclosure, will be aware of various alternative or additional forms and/or configurations that a motor may take or exemplify as consistent with this disclosure. In addition to inverter and/or switching power source, a circuit driving motor may include electronic speed controllers (not shown) or other components for regulating motor speed, rotation direction, torque, and the like.

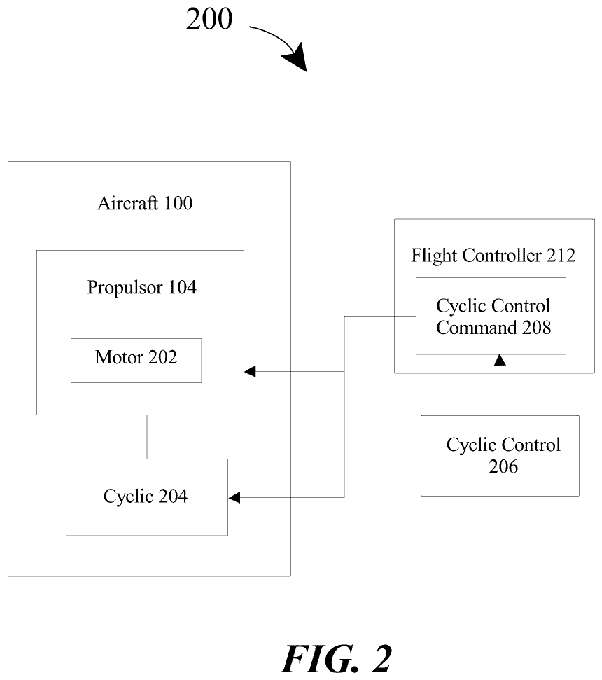

Still referring to FIG. 1, propulsor 104 may include two or more blades 108. In an embodiment, a propulsor 104 may include an advancing blade and a retreating blade. An advancing blade moves towards a nose 112 of an aircraft and a retreating blade moves towards a tail 116 of an aircraft. Blades 108 may be solid blades. As used herein, a “solid blade” is a blade such that is substantially rigid and not susceptible to bending during flight. Blade pitch on solid blades may not be individually adjustable, therefore cyclic controls may only control the blade pitch as a whole. Specifically, the advancing blade and the retreating blade may be considered a solid blade together and may not be individually adjusted and may be adjusted as a whole. As used herein, “blade pitch” is the angle of a blade. Cyclic controls are discussed in further detail in FIG. 2.

Still referring to FIG. 1, aircraft 100 may include a fuselage 120. In one or more embodiments, and as used in this disclosure, a “fuselage” is a main body of an aircraft. In one or more embodiments, fuselage 120 may include the entirety of aircraft except for a cockpit, nose, wings, empennage, nacelles, flight components, such as any and all control surfaces and propulsors. Fuselage 120 may contain a payload of aircraft. In one or more embodiments, airframe may form fuselage 120. For example, and without limitation, one or more structural elements of airframe may be used to form fuselage 120. For the purposes of this disclosure, “structural elements” include elements that physically support a shape and structure of an aircraft. Structural elements may take a plurality of forms, alone or in combination with other types. In one or more embodiments, a structural element may include a carbon fiber composite structure, as previously mentioned. The carbon fiber composite structure is configured to include high stiffness, high tensile strength, low weight to strength ratio, high chemical resistance, high temperature tolerance, and low thermal expansion. In one or more embodiments, a carbon fiber composite may include one or more carbon fiber structures comprising a plastic resin and/or graphite. For example, a carbon fiber composite may be formed as a function of a binding carbon fiber to a thermoset resin, such as an epoxy, and/or a thermoplastic polymer, such as polyester, vinyl ester, nylon, and the like thereof. Structural element may vary depending on a construction type of aircraft. For example, and without limitation, structural element may vary if forming the portion of aircraft that is fuselage 120. Fuselage 120 may include a truss structure. A truss structure may be used with a lightweight aircraft and include welded steel tube trusses. A “truss,” as used in this disclosure, is an assembly of beams that create a rigid structure, often in combinations of triangles to create three-dimensional shapes. A truss structure may alternatively comprise wood construction in place of steel tubes, or a combination thereof. In embodiments, structural elements may include steel tubes and/or wood beams

Referring now to FIG. 2, a system 200 for propulsor cyclic control on an electric aircraft is shown. System 200 includes a propulsor 104 configured to propel aircraft 100. Aircraft 100, as discussed above, may be an electric vertical takeoff and landing aircraft (eVTOL). Propulsor 104 may be a lift propulsor. Propulsor 104 may include solid blades, as discussed above. In an embodiment, system 200 may be used to reduce asymmetric loads due to flight. In edgewise flight, for example, these lift propulsors may experience significant off axis torque due to the asymmetrical forces as the propulsor blades are travelling horizontally through the air. This torque may be transferred to the rotating mechanisms of the system, such as the rotors, and can cause significant stress or damage to the drive motors (e.g. direct drive motors) due to shrinkage in size of clearance gaps and undesirable contact between components. As used in this disclosure, “edgewise flight” is a flight orientation wherein an air stream is substantially directed at an edge of a propeller. Edgewise flight (exaggerated for explanation) may occur when an aircraft is traveling in a direction orthogonal to a rotational axis of a propeller and parallel to a rotation plane of the propeller, causing an air stream to be directed at an edge of the propeller. Edgewise flight may also occur when an aircraft is traveling in a direction in which a component of the velocity of the aircraft is in a direction orthogonal to a rotational axis of a propulsor and parallel to rotation plane.

Still referring to FIG. 2, system 200 includes a motor 202. A motor 202 may be consistent with any motor as discussed herein. In one or more embodiments, motor may be configured to power propulsor 104. Motor may include a rotor, stator, motor shaft, and the like, as shown, as a non-limiting example, in FIG. 6. Motor may be at least partially disposed in an airframe of aircraft 100, such as a boom or a wing of aircraft 100. Rotor of motor may rotate about a central axis of motor. As used in this disclosure, a “motor” is a device, such as an electric motor, that converts electrical energy into mechanical movement. Motor 202 may include an electric motor. Electric motor may be driven by direct current (DC) electric power. As an example, and without limitation, electric motor may include a brushed DC electric motor or the like. An electric motor may be, without limitation, driven by electric power having varying or reversing voltage levels, such as alternating current (AC) power as produced by an alternating current generator and/or inverter, or otherwise varying power, such as produced by a switching power source. Electric motor may include, for example and without limitation, brushless DC electric motors, permanent magnet synchronous an electric motor, switched reluctance motors, induction motors, and the like. In addition to an inverter and/or a switching power source, a circuit driving electric motor may include electronic speed controllers (not shown) or other components for regulating motor speed, rotation direction, and/or dynamic braking. Motor may be used in an electric vehicle such as an electric automobile and an electric aircraft, including an electrical vertical takeoff and landing (eVTOL) aircraft, a commercial aircraft, an unmanned aerial vehicle, a rotorcraft, and the like. Propulsor assembly components may be consistent with disclosure of propulsor assembly components in U.S. patent application Ser. No. 17/563,498 filed on Dec. 28, 2021 and titled “AN ELECTRIC AIRCRAFT LIFT MOTOR WITH AIR COOLING”, in U.S. patent application Ser. No. 17/732,791 filed on Apr. 29, 2022 and titled “MAGNETIC LOCKING SYSTEM OF AN ELECTRIC AIRCRAFT ROTOR AND METHODS THEREOF”, in U.S. patent application Ser. No. 17/702,069 filed on Mar. 23, 2022 and titled “A DUAL-MOTOR PROPULSION ASSEMBLY”, in U.S. patent application Ser. No. 17/704,798 filed on Mar. 25, 2022 and titled “ROTOR FOR AN ELECTRIC AIRCRAFT MOTOR”, all of which are incorporated by reference herein in their entirety.

Still referring to FIG. 2, system 200 includes a cyclic 204. As used herein, a “cyclic” is a device configured to control a rotor to change a direction of movement. A cyclic may be used to control a rotor of a propulsor 104 to change a pitch of the propulsor blades as a function of rotational position. A cyclic control 206 may be located in a fuselage of an aircraft 100. As used herein, a “cyclic control” is a device to control a cyclic. For example, a cyclic control 206 may be a joystick, control stick, lever, button, or the like. Fuselage is shown in FIG. 1. Specifically, a cyclic control 206 may be located next to a pilot's seat. Alternatively, cyclic control 206 may be located remotely from aircraft 100 in another location, while being communicatively connected to aircraft 100. Communicative connection disclosed herein is further described below.

Still referring to FIG. 2, cyclic control 206 may be configured to generate a cyclic control command 208. Cyclic control command 208 may be generated as a function of a pilot input. As used herein, a “pilot input” is a manipulation of one or more elements that corresponds to a desire to affect an aircraft's state. For example, a pilot input may be a manipulation of cyclic control 206 to change an aircraft's direction. In an embodiment, manipulation of cyclic control 206 may include forward, backward, left, or right pilot inputs. Forward pilot input may be an input in the direction of the nose of the aircraft 100. Backwards pilot input may be an input in the direction of the tail of the aircraft 100. Left pilot input may perpendicular and to the left of the forward pilot input. Right pilot input may be perpendicular and to the right of the forward pilot input. Forward and backward pilot input may correspond to a change in pitch attitude of aircraft 100, which may result in climbing or descending flight. Left and right pilot input may correspond to a change in roll of the aircraft 100, which may result in a change in direction of the aircraft 100. As used herein, “cyclic control command” is a signal describing the pilot input. Cyclic control command may include an electronic signal from the physical manipulation of a pilot input, such as pulling a lever or pushing a button. Electrical signals may include analog signals, digital signals, periodic or aperiodic signal, step signals, unit impulse signal, unit ramp signal, unit parabolic signal, signum function, exponential signal, rectangular signal, triangular signal, sinusoidal signal, sinc function, or pulse width modulated signal. A sensor may include circuitry, computing devices, electronic components or a combination thereof that translates pilot input into a cyclic control command 208 configured to be transmitted to any other electronic component. A sensor may be located on, near, or remote from cyclic 204 and/or cyclic control 206. Additionally, cyclic control 206 may be used to adjust a max change in pitch of a propulsor blade. For example, a pilot input and/or a flight controller 212 may set a max change in pitch of 15°, 10°, 1°, or the like. In such instances, cyclic 204 may only vary the angle of attack of the propulsor up to the max change in pitch angle. For the purposes of this disclosure, a “max change” is the maximum allowed change in the pitch of a propulsor blade that is permitted. In some embodiments, max change may be a limit that is imposed by flight controller 212.

Still referring to FIG. 2, a flight controller 212 is communicatively connected to propulsor 104, cyclic 204, and/or cyclic control 206. Flight controller 212 may include any computing device as described in this disclosure, including without limitation a micro flight controller, processor, microprocessor, digital signal processor (DSP), and/or system on a chip (SoC) as described in this disclosure. Computing device may include, be included in, and/or communicate with a mobile device such as a mobile telephone or smartphone. Flight controller 212 may include a single computing device operating independently, or may include two or more computing device operating in concert, in parallel, sequentially or the like; two or more computing devices may be included together in a single computing device or in two or more computing devices. Flight controller 212 may interface or communicate with one or more additional devices as described below in further detail via a network interface device. Network interface device may be utilized for connecting flight controller 212 to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. Flight controller 212 may include but is not limited to, for example, a computing device or cluster of computing devices in a first location and a second computing device or cluster of computing devices in a second location. Flight controller 212 may include one or more computing devices dedicated to data storage, security, distribution of traffic for load balancing, and the like. Flight controller 212 may distribute one or more computing tasks as described below across a plurality of computing devices of computing device, which may operate in parallel, in series, redundantly, or in any other manner used for distribution of tasks or memory between computing devices. Flight controller 212 may be implemented using a “shared nothing” architecture in which data is cached at the worker, in an embodiment, this may enable scalability of system 200 and/or computing device.

Still referring to FIG. 2, flight controller 212 may be designed and/or configured to perform any method, method step, or sequence of method steps in any embodiment described in this disclosure, in any order and with any degree of repetition. For instance, flight controller 212 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Flight controller 212 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

Still referring to FIG. 2, flight controller 212 may be configured to receive the cyclic control command 208 from the cyclic control 206 and adjust the propulsor 104 and/or cyclic 204 as a function of the cyclic control command 208. In an embodiment, cyclic control command 208 may be configured to control the angle of attack of a blade/blades. This may occur at any point during the 360-degree rotation of a blade. The angle of attack (AOA) is an angle between the body's reference line and the oncoming flow. In aerodynamics, angle of attack may specify the angle between a chord line of a wing of an aircraft and a vector representing a relative motion between the aircraft and atmosphere. In an embodiment, cyclic control command 208 may control blade pitch, wherein blade pitch is the angle of attack of a blade. In an embodiment, the ability to vary blade pitch may allow for lower forces on the rotors, as the rotors may not be completely rigid. In some embodiments, cyclic control command 208 may control max blade pitch, as discussed above. In an embodiment, flight controller 212 may actuate and/or adjust a rotor to control an angle of attack of propulsor blades. In some embodiments, cyclic control of blades of propulsor 104 may be active or passive. Active control of blades may include using actuators to maintain a position of propulsor blades. Passive control of blades may include allowing blades to flap due to aerodynamic forces acting on propulsor 104. Blade flapping may be used to counter asymmetric loads due to flight, as discussed above. Blade flapping may allow blades to respond to wind vectors created by the external environment of aircraft 100, which may allow blades to overcome aerodynamic differences over the blades. For example, there may be differences in lift and drag in the blades due to wind vectors and aircraft speed. Passive control of blades may also include using mechanical devices, such as springs, dampers, and the like, to adjust blade pitch. Mechanical devices may be used to equalize lift across the propulsor/rotor.

Still referring to FIG. 2, flight controller 212 may be configured to control a feedback mechanism and/or feedforward mechanism of the cyclic 204. Flight controller 212 may use airspeed of aircraft 100 to control/adjust cyclic 204. For example, for a given airspeed, flight controller 212 may adjust the max blade pitch of a propulsor 104. In some embodiments, a higher airspeed may equate to a larger max blade pitch. Additionally, or alternatively, flight controller 212 may control cyclic 204 using feedback from cyclic 204, such as from sensors on cyclic 204. In some embodiments, a high force on cyclic 204 and/or the rotor of the motor 202 may result in flight controller 212 adjusting the blade pitch. In other embodiments, feedback such as a detected change in airspeed of aircraft 100 may cause flight controller 212 to adjust the blade pitch.

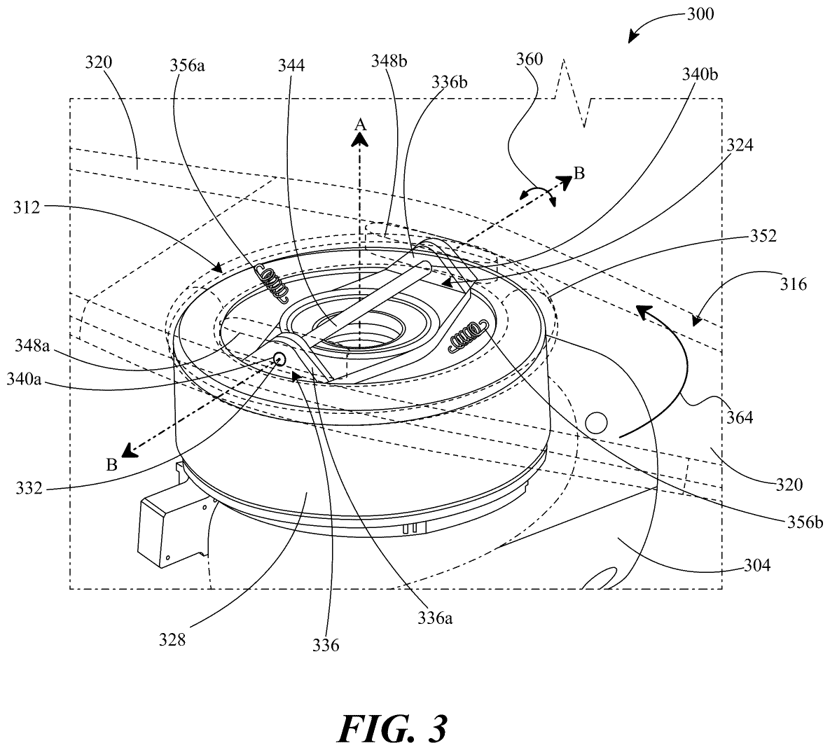

Now referring to FIG. 3, an exemplary embodiment of a teetering propulsor assembly 300 of an electric aircraft 304 is illustrated. Electric aircraft 304 (also referred to herein as an “aircraft”) may include an electrical vertical takeoff and landing (eVTOL) aircraft (as shown in FIG. 1), unmanned aerial vehicles (UAVs), drones, rotorcraft, commercial aircraft, and/or the like. Aircraft 304 may include one or more components that generate lift, including, without limitation, wings, airfoils, rotors, propellers, jet engines, or the like, or any other component or feature that an aircraft may use for mobility during flight. Aircraft 304 may be capable of rotor-based cruising flight, rotor-based takeoff, rotor-based landing, fixed-wing cruising flight, airplane-style takeoff, airplane-style landing, and/or any combination thereof. “Rotor-based flight,” as described in this disclosure, is where the aircraft generates lift and propulsion by way of one or more powered propulsors connected to a motor, such as a quadcopter, multi-rotor helicopter, or other vehicle that maintains its lift primarily using propulsors that produce an upward thrust force by imparting downward velocity to the surrounding fluid.

Still referring to FIG. 3, in one or more embodiments, teetering propulsor assembly 300 (also referred to in this disclosure as a “propulsor assembly” or “propulsor”) includes a propeller 316. Propeller 316 may include one or more blades 320 that radially extend from a hub 312 of propeller 316. For example, and without limitation, propeller 316 may include a plurality of blades 320, where each blade 320 may extend from hub 312 in an opposite direction from another blade 320. In some embodiments, propeller 316 may be a monolithic component, where blades 320 and hub 312 are a singular unit (shown in FIGS. 3 and 2A-2B). For example, and without limitation, propeller may include a rigid, monolithic component. In other embodiments, propeller 316 may include multiple components, where blades 320 and hub 312 are assembled components that are fixedly and/or moveably attached. In one or more embodiments, hub 312 may be pivotably attached to a base 328 of propulsor assembly 300. Base 328 may be rotatably affixed to electric vertical takeoff and landing aircraft 304 and configured to rotate about, for example, rotational axis A. Base 328, or at least a component of base 328, may rotate about axis A. Base 328 may be mechanically connected to a motor of propulsor assembly 300, either directly or indirectly, so that propulsor 316 may be driven by motor (shown in FIG. 6). In other embodiments, base 328 may include a motor and/or rotor of electric aircraft. In various embodiments, base 328 may be attached to or include a gearbox that translates mechanical movement from motor to propeller 316 so that propeller 316 may rotate about rotational axis A of propeller 316.

Still referring to FIG. 3, in one or more embodiments, motor may be configured to power propeller 316. Motor may include a rotor, stator, motor shaft, and the like, as shown in FIG. 6. Motor may be at least partially disposed in an airframe of aircraft 304, such as a boom or a wing of aircraft 304. Propulsor assembly 300 may include motor, which translates electrical power from a power source of aircraft 304 into a mechanical movement of propeller 316. Rotor of motor may rotate about a central axis of motor.

Still referring to FIG. 3, in some embodiments, motor may include an electric motor. Electric motor may be driven by direct current (DC) electric power. As an example, and without limitation, electric motor may include a brushed DC electric motor or the like. An electric motor may be, without limitation, driven by electric power having varying or reversing voltage levels, such as alternating current (AC) power as produced by an alternating current generator and/or inverter, or otherwise varying power, such as produced by a switching power source. Electric motor may include, for example and without limitation, brushless DC electric motors, permanent magnet synchronous an electric motor, switched reluctance motors, induction motors, and the like. In addition to an inverter and/or a switching power source, a circuit driving electric motor may include electronic speed controllers (not shown) or other components for regulating motor speed, rotation direction, and/or dynamic braking. Motor may be used in an electric vehicle such as an electric automobile and an electric aircraft, including an electrical vertical takeoff and landing (eVTOL) aircraft, a commercial aircraft, an unmanned aerial vehicle, a rotorcraft, and the like. Motor may include the exemplary embodiment of propulsor assembly 600 discussed in reference to FIG. 6. Hub 312 of propeller 316 may be mechanically connected to rotor, directly or indirectly. For example, and without limitation, hub 312 may be connected to a motor shaft that is rotated by rotor. In some embodiments, motor may include a direct drive motor, wherein one rotation of rotor also causes one rotation of hub 312 and/or propeller 316. In other embodiments, motor may include an indirect drive motor where, for example, a gearbox, pulleys, bearing, and/or various other components facilitate movement of propeller 316 by motor. Propulsor assembly components may be consistent with disclosure of propulsor assembly components in U.S. patent application Ser. No. 17/563,498 filed on Dec. 28, 2021 and titled “AN ELECTRIC AIRCRAFT LIFT MOTOR WITH AIR COOLING”, in U.S. patent application Ser. No. 17/732,791 filed on Apr. 29, 2022 and titled “MAGNETIC LOCKING SYSTEM OF AN ELECTRIC AIRCRAFT ROTOR AND METHODS THEREOF”, in U.S. patent application Ser. No. 17/702,069 filed on Mar. 23, 2022 and titled “A DUAL-MOTOR PROPULSION ASSEMBLY”, in U.S. patent application Ser. No. 17/704,798 filed on Mar. 25, 2022 and titled “ROTOR FOR AN ELECTRIC AIRCRAFT MOTOR”, all of which are incorporated by reference herein in their entirety.

Still referring to FIG. 3, in some embodiments, propulsor assembly 300 may be used to propel aircraft 304 through a fluid medium by exerting a force on the fluid medium. In one or more non-limiting embodiments, propulsor 300 may include a lift propulsor configured to create lift for aircraft 304. In other non-limiting embodiments, propulsor 300 may include a thrust element, which may be integrated into the propulsor 300. A thrust element may include any device or component that converts the mechanical energy of a motor, for instance in the form of rotational motion of a shaft, into thrust in a fluid medium. For example, a thrust element may include, without limitation, an impeller, a turbine, a pump-jet, a paddle or paddle-based device, and the like. As another non-limiting example, propulsor 300 may include a six-bladed pusher propulsor, such as a six-bladed propeller mounted behind the motor to ensure the drive shaft is in compression. Persons skilled in the art, upon reviewing the entirety of this disclosure, will be aware of various devices that may be used as propulsor assembly 300. In various embodiments, when a propeller of propulsor assembly 300 twists and pulls air behind it, it will, at the same time, push aircraft 304 with a relatively equal amount of force. The more air pulled behind aircraft, the more aircraft is pushed forward. In various embodiments, propeller 316 of propulsor assembly 300 may be substantially rigid and not susceptible to bending during flight.

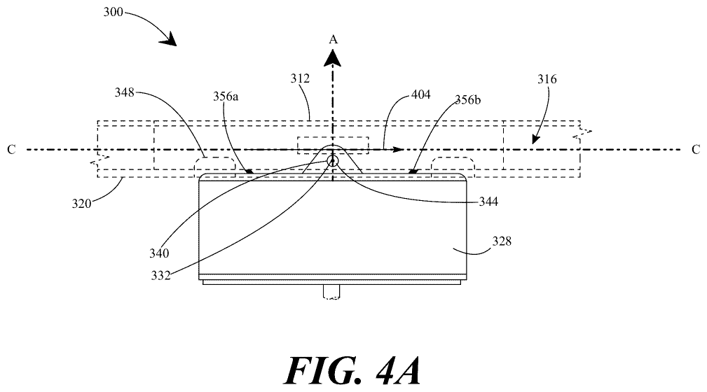

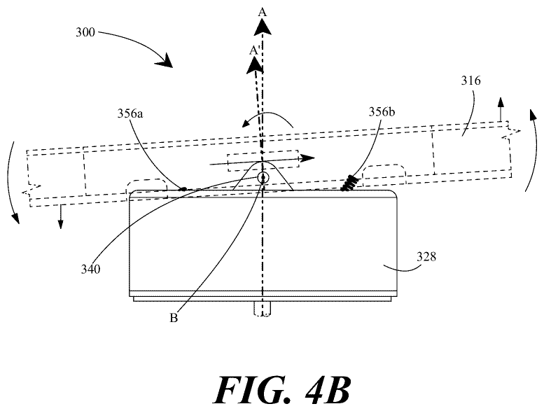

Still referring to FIG. 3, propulsor assembly 300 may be a lift propulsor oriented such that a rotation plane C (shown in FIGS. 4A and 4B) of propeller 316 is parallel with a ground supporting aircraft 304 when aircraft 304 is landed. As used in this disclosure, a “rotation plane” (also referred to herein as a “plane of rotation”) is a plane in which a propeller rotates. Rotation plane may be relatively orthogonal to an axis of rotation of propeller 316, such as axis A. A circumference of a rotational plane may be defined by a rotational path of a tip of blade 320 of propeller 316. As understood by one skilled in the art, assembly 300 may include various types of pitch-flap couplings, where hinge 336 may be oriented in various positions relative to rotation plane C. For instance, and without limitation, axis B may be at an angle relative to rotation plane C. For example, and without limitation, axis B may be perpendicular to rotation plane C. In another example, and without limitation, axis B may be at a non-perpendicular angle relative to rotation plane C. When there is a substantial force exerted on propulsor 316 that is orthogonal to rotational axis A, such as air resistance during edgewise flight, the force may cause significant stress and strain on propeller 316 and/or propulsor assembly 300. Edgewise flight (exaggerated for explanation) may occur when an aircraft is traveling in a direction orthogonal to a rotational axis of a propeller and parallel to a rotation plane of the propeller, causing an air stream to be directed at an edge of the propeller. Edgewise flight may also occur when an aircraft is traveling in a direction in which a component of the velocity of the aircraft is in a direction orthogonal to a rotational axis of a propulsor and parallel to rotation plane. Edgewise flight may cause issues with aircraft 304. For example, edgewise flight may cause excessive flapping of blades 320 during flight including flapping angulation. Thus, edgewise flight may lead to inadvertent displacement of propeller 316 that creates excessive loads on a propulsor assembly and/or components thereof.

Still referring to FIG. 3, assembly 300 includes a passive flap 324 mechanically connected to hub 312 of propeller 316, where passive flap 324 is configured to permit propeller 316 to pivot about a pivot point 332 of passive flap 324 (as indicated by directional arrow 360). Passive flap 324 may allow for deflections of propeller 316 during a transition of flight modes or edgewise flight to reduce the issues discussed above caused by edgewise flight. Passive flap 324 allow a rigid propeller to pivot relative to the rest of propulsor assembly. Passive flap 324 facilitates a certain amount of up-and-down tip, or blade displacement, per rotation of propeller 316 to reduce a load experienced by hub 312 and/or propulsor assembly 300, thus making propulsor assembly 300 more robust, especially against strong winds and dynamic operations of aircraft 304. Passive flap 324 may attach hub 312, and thus propeller 316, to base 328. In some embodiments, base 328 may be fixedly attached to a shaft, such as a motor shaft or a shaft of gearbox, which rotates propeller 316 about rotational axis A when motor is running (as indicated by directional arrow 364). Passive flap 324 may include one or more pivot points 332 so that propeller 316 may teeter about a pivot point. In one or more embodiments, when propeller 316 teeters about pivot point 332, rotation plane of propeller 316 may shift so that an orientation of rotation plane may vary relative to aircraft 304.

Still referring to FIG. 3, in one or more embodiments, passive flap 324 may include a hinge 336 that connects base 328 and hub 312 of propellor 316, where hinge 336 is configured to allow propeller 316 to pivot about a pivot point 332. Hinge 336 may provide pivot point 332 on which propeller 316 may teeter and/or tilt. Hinge 336 may be attached to base 328. As understood by one of ordinary skill in the art, hinge 336 may be various shapes and sizes without altering the spirit or the scope of this disclosure. In some embodiments, hinge 336 may be a circular or semi-circular shape. In some embodiments, hinge 336 may be a triangular shape (as shown). In other embodiments, hinge 336 may include a curved corner extending from base 328 and may form a fulcrum on which propeller 316 may teeter. Hinge 336 may include an aperture 340 through which a rod 344 may be disposed therethrough. Rod 344 may have a longitudinal axis B that propeller 316 may rotate about to teeter. In one or more embodiments, axis B may be parallel to a span, or tip-to-tip, axis of propeller 316. In other embodiments, axis B may not be perpendicular to the span axis of propeller 316. Thus, in some embodiments,

Still referring to FIG. 3, in one or more embodiments, hinge 336 may include two opposing hinges, one hinge on either side of axis A and either end of axis B. For instance, and without limitations, hinge 336 may include a pair of hinges, such as a first hinge 336a and a second hinge 336b. Each hinge 336a,b may include an aperture that is disposed therein, such as first aperture 340a and second aperture 340b, respectively. Rod 344 may traverse through each aperture 340a,b. For example, and without limitation, a first end of rod 344 may be disposed within aperture 340a, and a second end of rod 344 may be disposed within aperture 340b. Rod 344 may run through each aperture 340a,b in each hinge 336a,b to connect hub 312 to base 328. In one or more embodiments, rod may be fixedly connected to hub 312. In some embodiments, rod 344 may include an integrated component of hub 312. In other embodiments, rod 344 may include a separate component from hub 312 that may be attached to hub 312. In some embodiments, rod 344 may include two separate rods, where a first rod 344 may run through first aperture 340a of first hinge 336a and attach to hub 312 on either or both sides of first hinge 336a, and a second rod 344 may run through second aperture 340b of second hinge 336b and attach to hub 312 on either or both sides of second hinge 336b. Hub 312 may be attached to base 328 using hinges 336a,b so that if base 328, or at least a portion of base 328, moves (e.g., rotates), hub 312 may be moved in conjunction with base 328.

Still referring to FIG. 3, in one or more embodiments, hub 312 may include one or more recesses 348. Recess 348 may include a cavity or depression in an underside surface of hub 312 and/or propellor that faces base 328. Recess 348 may at least partially receive hinge 336 such that at least a portion of hinge 336, such as curved corner, is disposed within recess 348. In some embodiments, recess 348 may contact hinge 336, such as, for example, a rounded edge of hinge 336. Recess 348 may include a plurality of recesses, such as a recess 348a,b that each hinge 336a,b, respectively, may be disposed at least partially within. In some embodiments, a surface of hinge 336, such as a curved surface, may form a fulcrum against recess 348. In some embodiments, hinge 336 may be spaced from recess 348, and hinge 336 and recess 348 may be separated by a gap. In one or more embodiments, hub 312 may include a track 352 that forms a groove within surface of hub 312 that is facing base 328. Track 352 may provide space between hub 312 and base 328, where at least a portion of base 328 may be received by track 352. Thus, track 352 allows for propeller 316 to rotate and/or teeter without impediment from base 328. A shape of track 352 may be complementary to a shape of base 328. For example, and without limitation, shapes of track 352 may include a dome, half toroid, and the like.

Still referring to FIG. 3, in one or more embodiments, passive flap 324 may include one or more centering springs 356. Centering spring 356 (also referred to herein as a “spring”) may provide resistance in teetering movement of propeller 316. For example, and without limitation spring 356 may be configured to prevent or reduce teetering of propulsor 316. In some embodiments, centering spring 356 may have a spring constant large enough to prevent propulsor 316 from teetering about longitudinal axis B when the propulsor 316 rotates at a rate of approximately 30 Hertz or less. Centering spring may include a plurality of springs, where at least a first centering spring 356a is on a first side of longitudinal axis B and at least a second centering spring 356b is on a second side of longitudinal axis B. In one or more embodiments, centering spring 356 may be attached to base 328 at a proximal end of spring 356 and centering spring 356 may be attached to hub 312 at a distal end of spring 356. Though spring 356 is shown as a helical spring, as understood by one of skill in the art, spring 356 may be various other types of springs and/or any combination thereof. For example, and without limitation, spring 356 may include a compression spring, extension spring, torsion spring, constant force spring, constant rate spring, progressive rate spring, dual rate spring, linear spring, laminated or leaf spring, coil or helical spring, conical spring, flat spring, machined spring, molded spring, disc or Belleville spring (e.g., single or stacked), wave springs, and the like. Spring 356 may be position at various orientations. For example, and without limitation, a longitudinal axis of spring 356 may be angled relative to a connecting surface of base 328 and/or hub 312. In another example, and without limitation, the longitudinal axis of spring 356 may be orthogonal to a connecting surface of base 328 and/or hub 312. In one or more embodiments, propulsor assembly 300 may include a second motor and a second propeller driven by the second motor. The second propeller may include a second hub, a second plurality of blades extending from the hub, where the second hub is configured to rotate about a second rotational axis, and a second passive flap connected to the second hub. The second passive flap may include a second base rotatably affixed to the electric vertical takeoff and landing aircraft and configured to rotate about the second rotational axis, and a second hinge connecting the base and the hub of the propellor and configured to allow the propeller to pivot about a pivot point relative to the second base.

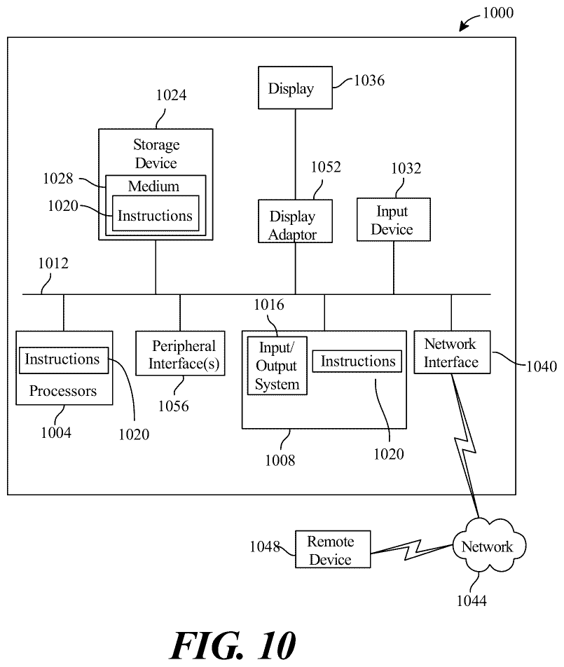

Still referring to FIG. 3, assembly 300 may include a locking mechanism (not shown) configured to lock passive flap 324, thereby preventing propeller 316 from teetering about longitudinal axis B. When locking mechanism is engaged, propulsor plane is fixed at an orientation orthogonal to rotational axis A. Locking mechanism may be configured to engage and/or disengage during flight of aircraft 304. For example, and without limitation, locking mechanism may be disengaged when aircraft 304 is performing a vertical takeoff and/or a vertical landing and engaged when the aircraft 304 is in fixed-wing flight. In some embodiments, locking mechanism may include a plurality of springs, where each spring is attached to hub 312 at a first end of the spring and attached to base 328 at a second end of the spring. In some embodiments, locking mechanism may include a spring on either side of longitudinal axis B. Locking mechanism may include a plurality of springs on either side of longitudinal axis B. Springs may have a spring constant large enough to prevent teetering of propeller 316 when propeller 316 rotates ten or fewer revolutions per second. For instance, and without limitation, springs may each have an initial tension that provides an internal force large enough to prevent extension of spring unless a substantial load or external force is applied. For example, and without limitation, springs may have a spring constant that prevent propulsor 316 from teetering on passive flap 324 except during forces caused by a rotation of propulsor 316 during operation of aircraft 304 in edgewise flight. In some embodiments, locking mechanism may include spring 356, where spring 356 may have a spring constant large enough to prevent propulsor 316 from teetering about longitudinal axis B when the propulsor 316 is rotating at a lower speed, such as less than 30 Hertz. In some embodiments, locking mechanism may be engaged or disengaged by an actuator. Actuator may be controlled by a controller, such as a computing device, as discussed further in FIG. 10. Controller may be communicatively connected to actuator and/or locking mechanism. In various embodiments, actuator may be configured to retract to essentially stiffen spring, which may engage locking mechanism. Actuator may be configured to extend to essentially loosen spring, which may disengage locking mechanism. Controller may adjust a position of actuator and alter a maximum rotational speed of propeller 316 in which locking mechanism is engaged and prevents propeller 316 from teetering about longitudinal axis B by an undesirable amount or completely. Controller may be communicatively connected to locking mechanism. For the purposes of this disclosure, “communicatively connected” means connected by way of a connection, attachment or linkage between two or more relata which allows for reception and/or transmittance of information therebetween. For example, and without limitation, this connection may be wired or wireless, direct or indirect, and between two or more components, circuits, devices, systems, and the like, which allows for reception and/or transmittance of data and/or signal(s) therebetween. Data and/or signals therebetween may include, without limitation, electrical, electromagnetic, magnetic, video, audio, radio and microwave data and/or signals, combinations thereof, and the like, among others. A communicative connection may be achieved, for example and without limitation, through wired or wireless electronic, digital or analog, communication, either directly or by way of one or more intervening devices or components. Further, communicative connection may include electrically coupling or connecting at least an output of one device, component, or circuit to at least an input of another device, component, or circuit. For example, and without limitation, via a bus or other facility for intercommunication between elements of a computing device. Communicative connecting may also include indirect connections via, for example and without limitation, wireless connection, radio communication, low power wide area network, optical communication, magnetic, capacitive, or optical coupling, and the like. In some instances, the terminology “communicatively coupled” may be used in place of communicatively connected in this disclosure. Controller may be configured to engage and/or disengage locking mechanism. For example, controller may disengage locking mechanism to unlock passive flap 324 when aircraft 304 performs a vertical takeoff and engage the locking mechanism, thereby locking passive flap 324, when the aircraft 304 is in fixed-wing flight. Transition between flight modes of an electric aircraft may be consistent with disclosure of U.S. patent application Ser. No. 17/563,498 filed on Dec. 28, 2021 and titled “AN ELECTRIC AIRCRAFT LIFT MOTOR WITH AIR COOLING,” and of U.S. patent application Ser. No. 17/825,371 filed on May 26, 2022 and titled “AN APPARATUS FOR GUIDING A TRANSITION BETWEEN FLIGHT MODES OF AN ELECTRIC AIRCRAFT,” all of which is incorporated by reference herein in its entirety

Still referring to FIG. 3, in some embodiments, controller may include any computing device as described in this disclosure, including without limitation a microcontroller, processor, microprocessor, digital signal processor (DSP), and/or system on a chip (SoC) as described in this disclosure. Computing device may include, be included in, and/or communicate with a mobile device such as a mobile telephone or smartphone. Controller may include a single computing device operating independently, or may include two or more computing device operating in concert, in parallel, sequentially or the like; two or more computing devices may be included together in a single computing device or in two or more computing devices. Controller may interface or communicate with one or more additional devices as described below in further detail via a network interface device. Network interface device may be utilized for connecting controller to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. Controller may include but is not limited to, for example, a computing device or cluster of computing devices in a first location and a second computing device or cluster of computing devices in a second location. Controller may include one or more computing devices dedicated to data storage, security, distribution of traffic for load balancing, and the like. Controller may distribute one or more computing tasks as described below across a plurality of computing devices of computing device, which may operate in parallel, in series, redundantly, or in any other manner used for distribution of tasks or memory between computing devices. Controller may be implemented using a “shared nothing” architecture in which data is cached at the worker, in an embodiment, this may enable scalability of assembly 300 and/or computing device.

Still referring to FIG. 3, controller may be designed and/or configured to perform any method, method step, or sequence of method steps in any embodiment described in this disclosure, in any order and with any degree of repetition. For instance, controller may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Controller may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

Referring now to FIGS. 4A and 4B, an exemplary movement of teetering propulsor assembly 300 is illustrated. As shown in FIG. 4A, propeller 316 may have a rotational axis A that is in an initial position. In some embodiments, initial position of axis A may be predetermined by a manufacturer or user of aircraft 304. In some embodiments, in initial position, propeller 316 may share a rotational axis with base 328 when propeller is not teetering about axis B. For example, and without limitation, propeller 316 may share a rotational axis with a shaft of base 328, gearbox, or motor that facilitates rotation of propeller 316. When propeller 316 is not teetering, springs 356 may both be in a resting and/or initial position. For example, and without limitation, in a resting position, each spring 356a,b may be of a relatively equal length relative to the other spring 356b,a.

As shown in FIG. 4B, rotational axis of propeller 316 may move to a second position, as indicated by rotational axis A, as propeller 316 teeters and/or tilts relative to aircraft 304. In an exemplary embodiment, propeller 316 may not share a rotational axis with base 328 when propeller 366 is teetering about axis B. For instance, and without limitation, rotational axis A of propeller 316 is not parallel to a rotational axis of base 328. When propeller 316 is teetering, springs 356 may be in a displaced position. For example, and without limitation, in a displaced position, a length of each spring 356a,b may vary relative to the other spring 356b,a. A displaced position of spring 356 may include a position that places spring 356 in tension or compression. In a non-limiting embodiment, during teetering of propeller 316, first spring 356a may compress while second spring 356b may simultaneously extend, which allows propeller 316 to tilt relative to base 328, resulting in deflections of propeller 316 to reduce strain experienced by hub 312 and/or propulsor assembly 300.

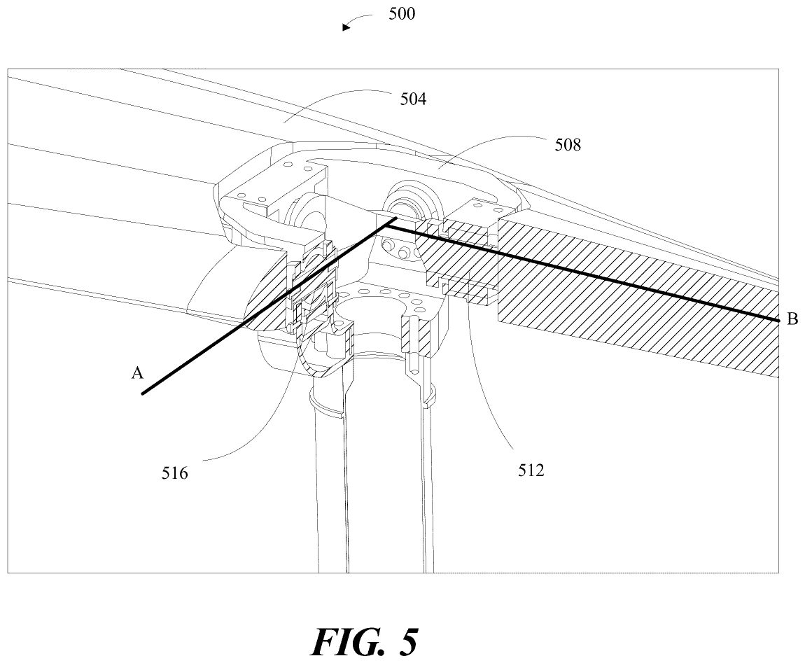

Now referring to FIG. 5, an exemplary embodiment of a combined cyclic and teeter system 500 of an electric vertical takeoff and landing (eVTOL) aircraft is shown. In some embodiments, system 500 may include an eVTOL aircraft. The eVTOL aircraft disclosed herein is further described with respect to FIG. 1. In some embodiments, the eVTOL aircraft may include a motor. The motor disclosed herein may be consistent with motor 202 and a motor disclosed with respect to FIG. 3. In some embodiments, the eVTOL aircraft may include a propulsor. The propulsor disclosed herein may be consistent with propulsor 104 and/or propulsor 300. In some embodiments, the propulsor may include a lift propulsor. The lift propulsor disclosed herein is further described with respect to FIG. 1-3. In some embodiments, the propulsor may include a propeller. The propeller disclosed herein may be consistent with a propeller disclosed with respect to FIG. 1. and/or propeller 316. In some embodiments, the propeller may include blade 504. Blade 504 disclosed herein may be consistent with blades 108 and/or blades 320. In some embodiments, blade 504 includes a rigid blade. The rigid blade disclosed herein may be consistent with a solid blade disclosed above. In some embodiments, the propeller may include a plurality of blades 504. As a non-limiting example, the propeller may include two blades 504, three blades 504, four blades 504, and the like. In some embodiments, the plurality of blade 504 may include a pitch that is fixed to one another. As a non-limiting example, the propeller may include two blades 504 wherein each of the two blades 504 includes a pitch that is fixed equally and opposite to one another. In some embodiments, the propeller may include a hub 508. The hub 508 disclosed herein may be consistent with hub 312 and/or hub 616. In some embodiments, cyclic 512 and passive flap 516 may be attached to the hub 508 as shown in FIG. 5.

Still referring to FIG. 5, in some embodiments, system 500 may include cyclic 512. Cyclic 512 disclosed herein may be consistent with cyclic 204. In some embodiments, cyclic 512 may be configured to change a pitch of blades 504 of a propeller. The pitch disclosed herein may be consistent with blade pitch disclosed above. As a non-limiting example, the pitch may include 5-degree, 12-degree, 15-degree, 30-degree, 40-degree, 60-degree, and the like. In some embodiments, the pitch may be measured relative to a fuselage of an aircraft. The fuselage disclosed herein is further described above. In some embodiments, cyclic 512 may be configured to control a pitch of a blade 504 of an eVTOL aircraft, wherein the blades 504 are rigidly fixed and changing the pitch of one blade may affect an opposing blade in an equally and in an opposite direction. In some embodiments, cyclic 512 may allow the blades to rotate about axis A. In some embodiments, cyclic 512 may be configured to control steady loads from edgewise flight. In some embodiments, the steady loads may be anticipated by flight speed. Additionally, the edgewise flight disclosed herein is further disclosed above. In some embodiments, the edgewise flight may occur when an aircraft is traveling in a direction orthogonal to a rotational axis of a propeller and parallel to a rotation plane of the propeller (as may be the case for a lift propulsor), causing an air stream to be directed at an edge of the propeller. In some embodiments, the edgewise flight may also occur when an aircraft is traveling in a direction in which a component of the velocity of the aircraft is in a direction orthogonal to a rotational axis of a propulsor and parallel to rotation plane. In some embodiments, the edgewise flight may cause issues with aircraft. For example, without limitation, the edgewise flight may cause excessive flapping of blades 504 during a flight. Thus, the edgewise flight may lead to inadvertent displacement of propeller that creates excessive loads on a propulsor assembly and/or components thereof. In some embodiments, cyclic may be configured to reduce excessive flapping of blades 504 by adjusting the pitch of blades 504. In some embodiments, cyclic 512 may include feedforward control to reduce imbalance force on a propeller. As used in this disclosure, a “feedforward control” is a control that measures disturbance variables and takes corrective action before the disturbance variables disturbs a flight. The feedforward control disclosed herein is described above. As a non-limiting example, the imbalance force may include loading due to the excessive flapping of blades 504, vibration of blades 108, and the like. As a non-limiting example, cyclic 512 may reduce the imbalance force on the propeller that is generated from rotating a lift propulsor by adjusting the pitch of blades 504 to be steeper. In some embodiments, the cyclic 512 may not be used to control the attitude of the aircraft. Instead, the rotations per minute (RPM) of the blades 504 may be used to control attitude. For example, in the case of an eVTOL with four lift propulsors, the RPM of the blades 504 of each lift propulsor may be adjusted to create differing lift vectors. The difference in lift vectors may cause a moment on the eVTOL which may cause an attitude change in the eVTOL.

With continued reference to FIG. 5, in some embodiments, eVTOL aircraft may include a cyclic control. The cyclic control disclosed herein may be consistent with cyclic control 206 described with respect to FIG. 2. In some embodiments, the cyclic control may be positioned in a fuselage of the eVTOL aircraft. In some embodiments, the cyclic control may be controlled by a pilot to control cyclic 512. In some embodiments, the eVTOL aircraft may include a flight controller communicatively connected with the propulsor and the cyclic 512. In some embodiments, the flight controller may be configured to adjust a change in pitch as a function of the cyclic control. The flight controller disclosed herein may be consistent with flight controller 212, flight controller 507 and any flight controllers disclosed in the entirety of this disclosure. As a non-limiting example, a pilot may control a cyclic control to move the eVTOL aircraft forward, then cyclic 512 may pitch blades 504 about axis A. As a non-limiting example, the pitch may include 5 degree, 12 degree, 15 degree, 30 degree, 40 degree, 60 degree, and the like.

Still referring to FIG. 5, in some embodiments, system 500 may include passive flap 516. The passive flap 516 disclosed herein may be consistent with a passive flap disclosed with respect to FIG. 3 and FIGS. 4A-4B. In some embodiments, the passive flap 516 may be used to allow for deflections of the propulsor during a transition of flight modes or edgewise flight. In some embodiments, the passive flap 516 may be configured to passively control flight transients. In some embodiments, the flight transients may include wind gusts. As used in this disclosure, “wind gust” is a sudden, brief increase in speed of the wind from any direction. As a non-limiting example, eVTOL aircraft that is flying forward may get the wind gust from a right side. In some embodiments, the flight transients may include a transition point of flight modes. As a non-limiting example, the transition from forward flight to hover mode may cause the flight transients. As another non-limiting example, the transition from vertical takeoff to forward flight may cause the flight transients. In some embodiments, the passive flap 516 may allow a propeller to rotate about axis B as a function of the flight transients. As a non-limiting example, when the wind gusts come from the right side of the eVTOL aircraft, passive flap 516 may allow the blades 504 to arc towards left. As another non-limiting example, when the wind gusts come from the right side of the eVTOL aircraft, passive flap 516 may allow the blades 504 to arc towards right.

Still referring to FIG. 5, in some embodiments, the passive flap 516 may include a base rotatably affixed to the propulsor and configured to rotate about a rotational axis. In some embodiments, the passive flap 516 may include a hinge connecting the base and the propeller and configured to allow the propeller to pivot about a pivot point of the hinge. The hinge disclosed herein may be consistent with hinge 336 described with respect to FIG. 3. In some embodiments, the hinge may include an aperture. The aperture disclosed herein may be consistent with aperture 340 described with respect to FIG. 3. In some embodiments, the hinge may include a rod having a longitudinal axis. In some embodiments, the rod may traverse through the aperture of the hinge and a portion of the propellor to create the pivot point at the hinge between the base and the propeller allowing the propeller to pivot about the longitudinal axis of the rod. The rod disclosed herein may be consistent with rod 344 described with respect to FIG. 3.

Still referring to FIG. 5, in some embodiments, passive flap 518 may passively control flight transients while cyclic 512 controls steady loads from a flight. As used in this disclosure, a “flight transient” is a force that lasts only for a short time during a flight. As a non-limiting example, the flight may include an edgewise flight and the flight transients may include wind gusts. As a non-limiting example, passive flap 518 may passively rotate the propeller about axis B when the eVTOL aircraft experiences wind gusts while cyclic 512 that is controlled by a cyclic control through a flight controller which controls steady loads resulting from the edgewise flight by rotating about axis A.

Referring now to FIG. 6, an embodiment of an integrated electric propulsion assembly 600 is illustrated. Integrated electric propulsion assembly 600 may include at least a stator 604. Stator 604, as used herein, is a stationary component of a motor and/or motor assembly. In an embodiment, stator 604 includes at least a first magnetic element 608. As used herein, first magnetic element 608 is an element that generates a magnetic field. For example, first magnetic element 608 may include one or more magnets which may be assembled in rows along a structural casing component. Further, first magnetic element 608 may include one or more magnets having magnetic poles oriented in at least a first direction. The magnets may include at least a permanent magnet. Permanent magnets may be composed of, but are not limited to, ceramic, alnico, samarium cobalt, neodymium iron boron materials, any rare earth magnets, and the like. Further, the magnets may include an electromagnet. As used herein, an electromagnet is an electrical component that generates magnetic field via induction; the electromagnet may include a coil of electrically conducting material, through which an electric current flow to generate the magnetic field, also called a field coil of field winding. A coil may be wound around a magnetic core, which may include without limitation an iron core or other magnetic material. The core may include a plurality of steel rings insulated from one another and then laminated together; the steel rings may include slots in which the conducting wire will wrap around to form a coil. A first magnetic element 608 may act to produce or generate a magnetic field to cause other magnetic elements to rotate, as described in further detail below. Stator 604 may include a frame to house components including at least a first magnetic element 608, as well as one or more other elements or components as described in further detail below. In an embodiment, a magnetic field can be generated by a first magnetic element 608 and can comprise a variable magnetic field. In embodiments, a variable magnetic field may be achieved by use of an inverter, a controller, or the like. In an embodiment, stator 604 may have an inner and outer cylindrical surface; a plurality of magnetic poles may extend outward from the outer cylindrical surface of the stator. In an embodiment, stator 604 may include an annular stator, wherein the stator is ring-shaped. In an embodiment, stator 604 is incorporated into a DC motor where stator 604 is fixed and functions to supply the magnetic fields where a corresponding rotor, as described in further detail below, rotates.

Still referring to FIG. 6, integrated electric propulsion assembly 600 may include a propulsor 104. In embodiments, propulsor 104 can include an integrated rotor. As used herein, a rotor is a portion of an electric motor that rotates with respect to a stator of the electric motor, such as stator 604. A propulsor, as used herein, is a component or device used to propel a craft by exerting force on a fluid medium, which may include a gaseous medium such as air or a liquid medium such as water. Propulsor 104 may be any device or component that consumes electrical power on demand to propel an aircraft or other vehicle while on ground and/or in flight. Propulsor 104 may include one or more propulsive devices. In an embodiment, propulsor 104 can include a thrust element which may be integrated into the propulsor. A thrust element may include any device or component that converts the mechanical energy of a motor, for instance in the form of rotational motion of a shaft, into thrust in a fluid medium. For example, a thrust element may include without limitation a marine propeller or screw, an impeller, a turbine, a pump-jet, a paddle or paddle-based device, or the like. As another non-limiting example, at least a propulsor may include an eight-bladed pusher propeller, such as an eight-bladed propeller mounted behind the engine to ensure the drive shaft is in compression. Persons skilled in the art, upon reviewing the entirety of this disclosure, will be aware of various devices that may be used as at least a thrust element. As used herein, a propulsive device may include, without limitation, a device using moving or rotating foils, including without limitation one or more rotors, an airscrew or propeller, a set of airscrews or propellers such as contra-rotating propellers, a moving or flapping wing, or the like.

Still referring to FIG. 6 in an embodiment, propulsor 104 may include at least a blade. As another non-limiting example, a propulsor may include an eight-bladed pusher propeller, such as an eight-bladed propeller mounted behind the engine to ensure the drive shaft is in compression. Persons skilled in the art, upon reviewing the entirety of this disclosure, will be aware of various devices that may be used as propulsor 104. In an embodiment, when a propulsor twists and pulls air behind it, it will, at the same time, push the aircraft forward with an equal amount of force. The more air pulled behind the aircraft, the more the aircraft is pushed forward.

Still referring to FIG. 6, in an embodiment, thrust element may include a helicopter rotor incorporated into propulsor 104. A helicopter rotor, as used herein, may include one or more blade or wing elements driven in a rotary motion to drive fluid medium in a direction axial to the rotation of the blade or wing element. Its rotation is due to the interaction between the windings and magnetic fields which produces a torque around the rotor's axis. A helicopter rotor may include a plurality of blade or wing elements.

Still referring to FIG. 6, propulsor 104 can include a hub 616 rotatably mounted to stator 604. Rotatably mounted, as described herein, is functionally secured in a manner to allow rotation. Hub 616 is a structure which allows for the mechanically connected of components of the integrated rotor assembly. In an embodiment, hub 616 can be mechanically connected to propellers or blades. In an embodiment, hub 616 may be cylindrical in shape such that it may be mechanically joined to other components of the rotor assembly. Hub 616 may be constructed of any suitable material or combination of materials, including without limitation metal such as aluminum, titanium, steel, or the like, polymer materials or composites, fiberglass, carbon fiber, wood, or any other suitable material. Hub 616 may move in a rotational manner driven by interaction between stator and components in the rotor assembly. Persons skilled in the art, upon reviewing the entirety of this disclosure, will be aware of various structures that may be used as or included as hub 616, as used and described herein.

Still referring to FIG. 6, propulsor 104 can include a second magnetic element 620, which may include one or more further magnetic elements. Second magnetic element 620 generates a magnetic field designed to interact with first magnetic element 608. Second magnetic element 620 may be designed with a material such that the magnetic poles of at least a second magnetic element are oriented in an opposite direction from first magnetic element 608. In an embodiment, second magnetic element 620 may be affixed to hub 616. Affixed, as described herein, is the attachment, fastening, connection, and the like, of one component to another component. For example, and without limitation, affixed may include bonding the second magnetic element 620 to hub 616, such as through hardware assembly, spot welding, riveting, brazing, soldering, glue, and the like. Second magnetic element 620 may include any magnetic element suitable for use as a first magnetic element 608. For instance, and without limitation, second magnetic element may include a permanent magnet and/or an electromagnet. Second magnetic element 620 may include magnetic poles oriented in a second direction opposite of the orientation of the poles of first magnetic element 608. In an embodiment, electric propulsion assembly 600 includes a motor assembly incorporating stator 604 with a first magnet element and second magnetic element 620. First magnetic element 608 includes magnetic poles oriented in a first direction, a second magnetic element includes a plurality of magnetic poles oriented in the opposite direction than the plurality of magnetic poles in the first magnetic element 608.

Still referring to FIG. 6, second magnetic element 620 may include a plurality of magnets attached to or integrated in hub 616. In an embodiment, hub 616 may incorporate structural elements of the rotor assembly of the motor assembly. As a non-limiting example hub 616 may include a motor inner magnet carrier 624 and motor outer magnet carrier 628 incorporated into the hub 616 structure. In an embodiment motor inner magnet carrier 624 and motor outer magnet carrier 628 may be cylindrical in shape. In an embodiment, motor inner magnet carrier 624 and motor out magnet carrier 616 may be any shape that would allow for a fit with the other components of the rotor assembly. In an embodiment, hub 616 may be short and wide in shape to reduce the profile height of the rotating assembly of electric propulsion assembly 600. Reducing the profile assembly height may have the advantage of reducing drag force on the external components. In an embodiment, hub 616 may also be cylindrical in shape so that fitment of the components in the rotor assembly are structurally rigid while leaving hub 616 free to rotate about stator.

In an embodiment, motor outer magnet carrier 628 may have a slightly larger diameter than motor inner magnet carrier 624, or vice-versa. First magnetic element 608 may be a productive element, defined herein as an element that produces a varying magnetic field. Productive elements will produce magnetic field that will attract and other magnetic elements, including a receptive element. Second magnetic element may be a productive or receptive element. A receptive element will react due to the magnetic field of a first magnetic element 608. In an embodiment, first magnetic element 608 produces a magnetic field according to magnetic poles of first magnetic element 608 oriented in a first direction. Second magnetic element 620 may produce a magnetic field with magnetic poles in the opposite direction of the first magnetic field, which may cause the two magnetic elements to attract one another. Receptive magnetic element may be slightly larger in diameter than the productive element. Interaction of productive and receptive magnetic elements may produce torque and cause the assembly to rotate. Hub 616 and rotor assembly may both be cylindrical in shape where rotor may have a slightly smaller circumference than hub 616 to allow the joining of both structures. Coupling of hub 616 to stator 604 may be accomplished via a surface modification of either hub 616, stator 604 or both to form a locking mechanism. Coupling may be accomplished using additional nuts, bolts, and/or other fastening apparatuses. In an embodiment, an integrated rotor assembly as described above reduces profile drag in forward flight for an electric aircraft. Profile drag may be caused by a number of external forces that the aircraft is subjected to. By incorporating a propulsor 104 into hub 616, a profile of integrated electric propulsion assembly 600 may be reduced, resulting in a reduced profile drag, as noted above. In an embodiment, the rotor, which includes motor inner magnet carrier 624, motor outer magnet carrier 628, propulsor 104 is incorporated into hub 616 to become one integrated unit. In an embodiment, inner motor magnet carrier 612 rotates in response to a magnetic field. The rotation causes hub 616 to rotate. This unit can be inserted into integrated electric propulsion assembly 600 as one unit. This enables ease of installation, maintenance, and removal.

Still referring to FIG. 6, stator 604 may include a through-hole 632. Through-hole 632 may provide an opening for a component to be inserted through to aid in attaching propulsor with integrated rotor to stator. In an embodiment, through-hole 632 may have a round or cylindrical shape and be located at a rotational axis of stator 604. Hub 616 may be mounted to stator 604 by means of a shaft 636 rotatably inserted though through hole 632. Through-hole 632 may have a diameter that is slightly larger than a diameter of shaft 636 to allow shaft 636 to fit through through-hole 632 to connect stator 604 to hub 616. Shaft 636 may rotate in response to rotation of propulsor 104.

Still referring to FIG. 6, integrated electric propulsion assembly 600 may include a bearing cartridge 640. Bearing cartridge 640 may include a bore. Shaft 636 may be inserted through the bore of bearing cartridge 640. Bearing cartridge 640 may be attached to a structural element of a vehicle. Bearing cartridge 640 functions to support the rotor and to transfer the loads from the motor. Loads may include, without limitation, weight, power, magnetic pull, pitch errors, out of balance situations, and the like. A bearing cartridge 640 may include a bore. a bearing cartridge 640 may include a smooth metal ball or roller that rolls against a smooth inner and outer metal surface. The rollers or balls take the load, allowing the device to spin. a bearing may include, without limitation, a ball bearing, a straight roller bearing, a tapered roller bearing or the like. a bearing cartridge 640 may be subject to a load which may include, without limitation, a radial or a thrust load. Depending on the location of bearing cartridge 640 in the assembly, it may see all of a radial or thrust load or a combination of both. In an embodiment, bearing cartridge 640 may join integrated electric propulsion assembly 600 to a structure feature. A bearing cartridge 640 may function to minimize the structural impact from the transfer of bearing loads during flight and/or to increase energy efficiency and power of propulsor. a bearing cartridge 640 may include a shaft and collar arrangement, wherein a shaft affixed into a collar assembly. A bearing element may support the two joined structures by reducing transmission of vibration from such bearings. Roller (rolling-contact) bearings are conventionally used for locating and supporting machine parts such as rotors or rotating shafts. Typically, the rolling elements of a roller bearing are balls or rollers. In general, a roller bearing is a is type of anti-friction bearing; a roller bearing functions to reduce friction allowing free rotation. Also, a roller bearing may act to transfer loads between rotating and stationary members. In an embodiment, bearing cartridge 640 may act to keep a propulsor 104 and components intact during flight by allowing integrated electric propulsion assembly 600 to rotate freely while resisting loads such as an axial force. In an embodiment, bearing cartridge 640 includes a roller bearing incorporated into the bore. a roller bearing is in contact with propulsor shaft 636. Stator 604 is mechanically coupled to inverter housing 640. Mechanically coupled may include a mechanical fastening, without limitation, such as nuts, bolts or other fastening device. Mechanically coupled may include welding or casting or the like. Inverter housing contains a bore which allows insertion by propulsor shaft 636 into bearing cartridge 640.

Still referring to FIG. 6, electric propulsion assembly 600 may include a motor assembly incorporating a rotating assembly and a stationary assembly. Hub 616, motor inner magnet carrier 624 and propulsor shaft 636 may be incorporated into the rotor assembly of electric propulsion assembly 600 which make up rotating parts of electric motor, moving between the stator poles and transmitting the motor power. As one integrated part, the rotor assembly may be inserted and removed in one piece. Stator 604 may be incorporated into the stationary part of the motor assembly. Stator and rotor may combine to form an electric motor. In embodiment, an electric motor may, for instance, incorporate coils of wire which are driven by the magnetic force exerted by a first magnetic field on an electric current. The function of the motor may be to convert electrical energy into mechanical energy. In operation, a wire carrying current may create at least a first magnetic field with magnetic poles in a first orientation which interacts with a second magnetic field with magnetic poles oriented in the opposite direction of the first magnetic pole direction causing a force that may move a rotor in a direction. For example, and without limitation, a first magnetic element 608 in electric propulsion assembly 600 may include an active magnet. For instance, and without limitation, a second magnetic element may include a passive magnet, a magnet that reacts to a magnetic force generated by a first magnetic element 608. In an embodiment, a first magnet positioned around the rotor assembly, may generate magnetic fields to affect the position of the rotor relative to the stator 604. A controller 904 may have an ability to adjust electricity originating from a power supply and, thereby, the magnetic forces generated, to ensure stable rotation of the rotor, independent of the forces induced by the machinery process. Electric propulsion assembly 600 may include an impeller 644 coupled with the shaft 636. An impeller, as described herein, is a rotor used to increase or decrease the pressure and flow of a fluid and/or air. Impeller 644 may function to provide cooling to electric propulsion assembly 600. Impeller 644 may include varying blade configurations, such as radial blades, non-radial blades, semi-circular blades and airfoil blades. Impeller 614 may further include single and/or double-sided configurations.

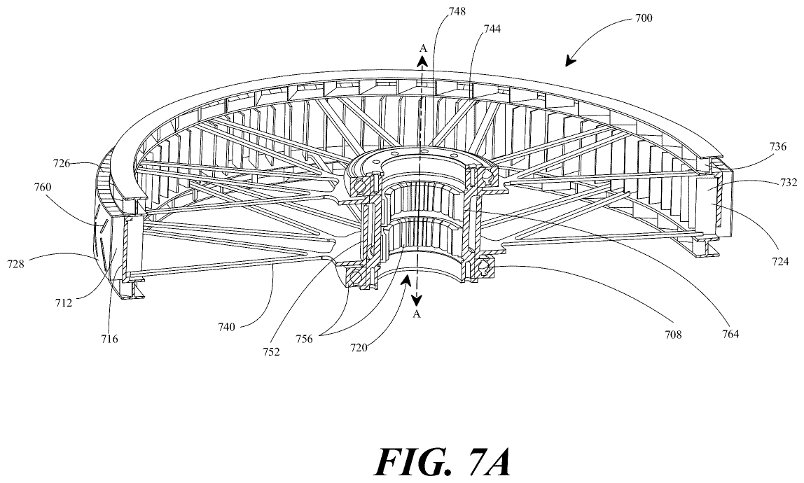

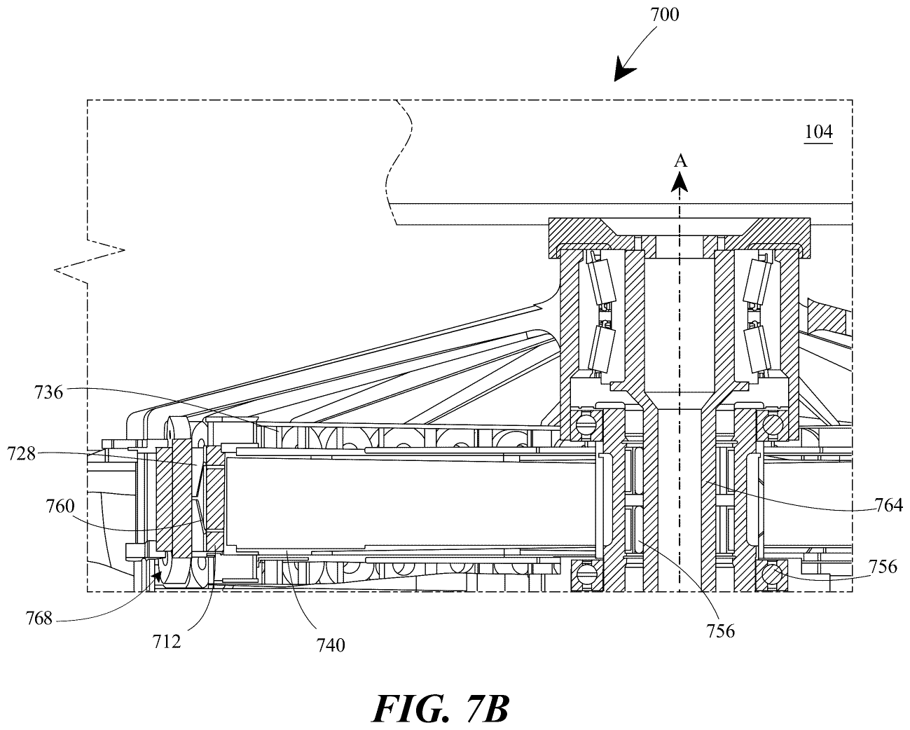

Referring now to FIGS. 7A and 7B, cross-sectional views of an exemplary embodiment of a rotor 700 of a motor of an electric aircraft are shown in accordance with one or more embodiments of the present disclosure. In one or more embodiments, motor may include a lift motor of a propulsor, as discussed further in this disclosure in FIG. 3. In one or more embodiments, rotor 700 includes a hub 708. Hub 708 may be a tubular structure. As used herein, a “hub” is a component that holds the propulsor. Hub 708 may be consistent with any hub as discussed herein. In one or more embodiments, inner surface 716 may define a lumen 720. Lumen 720 may be a longitudinal cavity that receives a roto shaft 764. Shaft 764 may be disposed within lumen 720 of hub 708 so that rotor 700 may rotate and simultaneously rotate shaft 764 which in turn rotates a propulsor. As used in this disclosure, a “lumen” is a central cavity, for example a tubular or cylindrical bore.

Still referring to FIGS. 7A and 7B, and in one or more embodiments, hub 708 may comprise an inner hub 704 and an outer hub 752. In one or more embodiments, outer hub 752 may be attached to a proximal end 748 of spokes 740 of rotor 700, as discussed further below. In one or more embodiments, inner hub 704 may be secured to outer hub 752 using a locking mechanism. A locking mechanism may be configured to removably attach sprag 756 to hub 708. A locking mechanism may include a bolted joint, dowels, key, spline, and the like. In one or more embodiments, the inner hub may include a sprag clutch 756, as discussed in more detail below.

Still referring to FIGS. 7A and 7B, and in one or more embodiments, rotor 700 includes a sprag 756. Sprag 756 may be disposed within inner hub 704. For example, and without limitation, sprag 756 may be attached to an inner surface 716 of inner hub 704. Sprag 756 may engage a rotor shaft (not shown) which allow for the rotational movement of rotor to be translated into a mechanical movement of, for example, a propulsor. Sprag 756 may include a sprag clutch. In one or more embodiments, sprag 756 may have a cage design, so that the sprags are less likely to lay down due to centrifugal force experienced when rotor is spinning. In one or more embodiments, sprag clutch 756 may include a maximum eccentricity of 90 microns.

Still referring to FIGS. 7A and 7B, rotor 700 includes a hoop 726 concentrically positioned about hub 724. Hoop 726 may share a central axis A with hub 724. In one or more embodiments, hoop 726 includes magnets 712, which are position along an outer circumference of hoop 726 and attached to an outer surface of hoop 726. As used herein, a “magnet” is a material or object that produces a magnetic field. As used herein, a “hoop” is a cylindrical component. In one or more embodiments, a current may flow through a plurality of windings of a stator 768 that then results in the generation of electrically-induced magnetic fields that interact with magnets 712 to rotate rotor 700 about central axis A. As used herein, a “stator” is a stationary portion of a motor. During operation, rotor 700 may rotate axially about central axis A while stator remains still; thus, rotor 700 is rotatable relative to stator.

Still referring to FIGS. 7A and 7B, and in one or more embodiments, magnets 712 of hoop 726 may be permanent magnets fixed to outer surface 772. Magnets 712 may be arranged concentrically to a central axis A of rotor 700. Thus, magnets 712 may be arranged in a ring along the outer circumference of hoop 726, which is defined by outer surface 772 of hoop 726. Magnets 712 may be arranged in a single ring or may be arranged in a plurality of rings along outer surface 772. Each magnet 712 may be positioned adjacent to another magnet 712 along convex outer surface so that stator 768 is continuously interacting with a magnet to produce a rotation of rotor 700. In one or more embodiments, hub and hoop may be made from various materials, such as, for example, steel. In an embodiment, rings and/or layers of rings of magnets 712 may be formed by using adhesive between each of the magnets 712. The adhesive may include epoxy which may be heat cure, UV cure, or the like. The ring of magnets may be formed by stacking layers of magnets on top of one another and using adhesive to adhere adjacent magnetic elements. The magnets may be rare earth magnets, including without limitation Neodymium magnets. Magnets and hoop may be consistent with any magnet or hoop as discussed herein.

Still referring to FIGS. 7A and 7B, and in one or more embodiments, magnets 712 may include a magnet array. In non-limiting embodiments, a magnet array may include a Halbach array. A Halbach array is a special arrangement of permanent magnets that augments the magnetic field on one side of the array while canceling the field to near zero on the other side of the array. In general, the Halbach array is achieved by having a spatially rotating pattern of magnetization where the poles of successive magnets are not necessarily aligned and differ from one to the next. Orientations of magnetic poles may be repeated in patterns or in successive rows, columns, and arrangements. An array, for the purpose of this disclosure is a set, arrangement, or sequence of items, in this case permanent magnets. The rotating pattern of permanent magnets can be continued indefinitely and have the same effect, and may be arranged in rows, columns, or radially, in a non-limiting illustrative embodiment. One of ordinary skill in the art would appreciate that the area that the Halbach array augments the magnetic field of may be configurable or adjustable.

Still referring to FIGS. 7A and 7B, and in one or more embodiments, hoop 726 may include cooling features, such as, for example, an integrated radial fan 732 or an integrated axial fan 736. A radial fan may comprise cooling fins positioned on an upper surface of hoop 726 and provide cooling to a stator when rotor 700 is rotating about central axis A. An axial fan may include fins positioned along an inner surface of hoop 726 and provide cooling to motor. Radial fan and/or axial fans may increase air flow in rotor 700 and cause convection cooling. Radial and axial fans may be consistent with motor cooling fans provided in the disclosure U.S. application Ser. No. 17/515,515 titled “AN ELECTRIC AIRCRAFT LIFT MOTOR WITH AIR COOLING”, which is incorporated in this disclosure in its entirety. In one or more embodiments, hoop 726 may include various types of materials, such as for example, titanium, steel, and the like.

Still referring to FIGS. 7A and 7B, and in one or more embodiments, a retention band 728 surrounds magnets 712. Additional disclosure on retention bands and magnets are discussed in FIGS. 7 and 5. Retention band 728 may be present around the outer surface of magnets 712. The outer surface of magnets 712 may be the surface opposite the surface in contact with hoop 726. Retention band 728 may be a sleeve of a solid material or an aggregation of individual materials that run along the outer surface of magnets 712. Retention band 728 may be made from various materials, such as stainless steel, titanium, carbon, carbon-composite, and the like. Retention band 728 and magnets 712 may have the same or similar coefficients of thermal expansion. As a result, retention band 728 and/or magnets 712 may expand or shrink at similar rates, allowing for uniform stress around the magnets 712. A similar coefficient of thermal expansion may allow for no point forces to form between the retention band 712 and magnets 712. As used herein, a “retention band” is a component for maintaining a position of the component it is surrounding. For example, a retention band may be configured to maintain a position of magnets 712 by providing inward forces around the magnets 712. For example, retention band 728 may provide stability for rotor 700 and prevent magnets 712 from lifting from outer surface 772 of hoop 726 due to centrifugal forces. Retention band 728 may include slits of various shapes and patterns to provide venting for temperature management purposes. For, example, slits 742 allow for air to pass through retention sleeve 728, allowing air to circulate through rotor 700 when rotor 700 is spinning about central axis A.

Still referring to FIGS. 7A and 7B, retention band 728 may be configured to reduce eddy currents. As used herein, “eddy currents” are loops of electrical current induced by a changing magnetic field. In an embodiment, the rotating stator magnetic field, as discussed in FIG. 3, may cause voltages in the stator and rotor. These voltages may cause small circulating currents to flow, which may be eddy currents. Eddy currents may serve no useful purpose in a motor and result in wasted power. A retention band 728 composed of a poor conductor, such as titanium, steel, plastics, rubber, and the like, may be used to reduce eddy currents. A poor conductor may be a material with a low conductivity. A low conductivity may be less than 3E6 S/m at 20° C. Additionally, the slits of retention band 728 may reduce eddy currents by breakup the area that the currents may circulate in.

Still referring to FIGS. 7A and 7B, and in one or more embodiments, rotor 700 includes a plurality of spokes 740, that radiate from hub 708 to connect hub 708 and hoop 726. Spokes 740 may extend radially outward from hub 708 to hoop 726. Spokes 740 may be positioned in various arrangement to provide structural support to rotor 700. In one or more embodiments, spokes 740 may be made from various materials, such as steel, titanium and the like. In some embodiments, hoop 726 and spokes 740 may be separate components that may be assembly together. In other embodiments, hoop 726 and spokes 740 may be a monolithic structure. For example, in some cases spokes may include a single element, such as without limitation a disc. Disc may be solid or may include holes. In one or more embodiments, a distal end 744 of each spoke may terminate at and/or be attached to hoop 726, and a proximal end of each spoke 740 may be attached to hub 708.

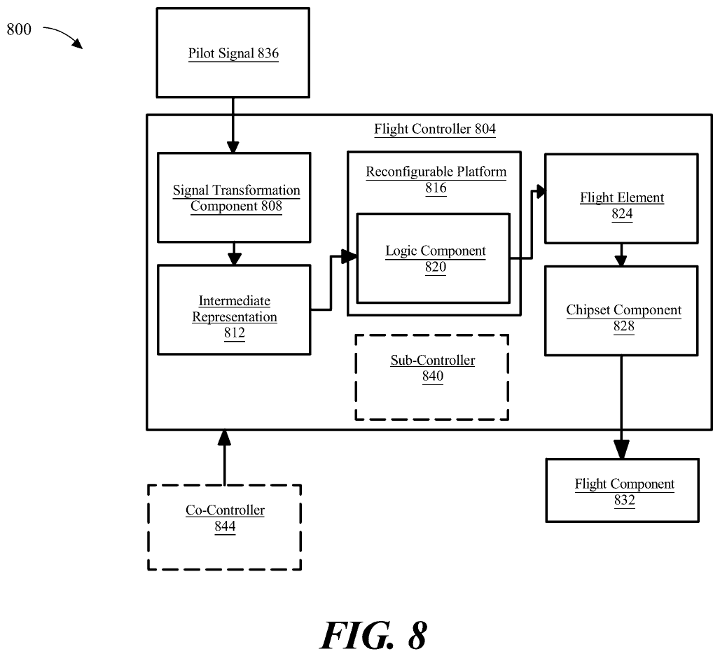

Now referring to FIG. 8, an exemplary embodiment 800 of a flight controller 804 is illustrated. As used in this disclosure a “flight controller” is a computing device of a plurality of computing devices dedicated to data storage, security, distribution of traffic for load balancing, and flight instruction. Flight controller 804 may include and/or communicate with any computing device as described in this disclosure, including without limitation a microcontroller, microprocessor, digital signal processor (DSP) and/or system on a chip (SoC) as described in this disclosure. Further, flight controller 804 may include a single computing device operating independently, or may include two or more computing device operating in concert, in parallel, sequentially or the like; two or more computing devices may be included together in a single computing device or in two or more computing devices. In embodiments, flight controller 804 may be installed in an aircraft, may control the aircraft remotely, and/or may include an element installed in the aircraft and a remote element in communication therewith.

Still referring to FIG. 8, in an embodiment 8, flight controller 804 may include a signal transformation component 808. As used in this disclosure a “signal transformation component” is a component that transforms and/or converts a first signal to a second signal, wherein a signal may include one or more digital and/or analog signals. For example, and without limitation, signal transformation component 808 may be configured to perform one or more operations such as preprocessing, lexical analysis, parsing, semantic analysis, and the like thereof. In an embodiment, and without limitation, signal transformation component 808 may include one or more analog-to-digital convertors that transform a first signal of an analog signal to a second signal of a digital signal. For example, and without limitation, an analog-to-digital converter may convert an analog input signal to a 10-bit binary digital representation of that signal. In another embodiment, signal transformation component 808 may include transforming one or more low-level languages such as, but not limited to, machine languages and/or assembly languages. For example, and without limitation, signal transformation component 808 may include transforming a binary language signal to an assembly language signal. In an embodiment, and without limitation, signal transformation component 808 may include transforming one or more high-level languages and/or formal languages such as but not limited to alphabets, strings, and/or languages. For example, and without limitation, high-level languages may include one or more system languages, scripting languages, domain-specific languages, visual languages, esoteric languages, and the like thereof. As a further non-limiting example, high-level languages may include one or more algebraic formula languages, business data languages, string and list languages, object-oriented languages, and the like thereof.

Still referring to FIG. 8, signal transformation component 808 may be configured to optimize an intermediate representation 812. As used in this disclosure an “intermediate representation” is a data structure and/or code that represents the input signal. Signal transformation component 808 may optimize intermediate representation as a function of a data-flow analysis, dependence analysis, alias analysis, pointer analysis, escape analysis, and the like thereof. In an embodiment, and without limitation, signal transformation component 808 may optimize intermediate representation 812 as a function of one or more inline expansions, dead code eliminations, constant propagation, loop transformations, and/or automatic parallelization functions. In another embodiment, signal transformation component 808 may optimize intermediate representation as a function of a machine dependent optimization such as a peephole optimization, wherein a peephole optimization may rewrite short sequences of code into more efficient sequences of code. Signal transformation component 808 may optimize intermediate representation to generate an output language, wherein an “output language,” as used herein, is the native machine language of flight controller 804. For example, and without limitation, native machine language may include one or more binary and/or numerical languages.

Still referring to FIG. 8, in an embodiment, and without limitation, signal transformation component 808 may include transform one or more inputs and outputs as a function of an error correction code. An error correction code, also known as error correcting code (ECC), is an encoding of a message or lot of data using redundant information, permitting recovery of corrupted data. An ECC may include a block code, in which information is encoded on fixed-size packets and/or blocks of data elements such as symbols of predetermined size, bits, or the like. Reed-Solomon coding, in which message symbols within a symbol set having q symbols are encoded as coefficients of a polynomial of degree less than or equal to a natural number k, over a finite field F with q elements; strings so encoded have a minimum hamming distance of k+1, and permit correction of (q−k−1)/2 erroneous symbols. Block code may alternatively or additionally be implemented using Golay coding, also known as binary Golay coding, Bose-Chaudhuri, Hocquenghuem (BCH) coding, multidimensional parity-check coding, and/or Hamming codes. An ECC may alternatively or additionally be based on a convolutional code.

Still referring to FIG. 8, in an embodiment, 8 flight controller 804 may include a reconfigurable hardware platform 816. A “reconfigurable hardware platform,” as used herein, is a component and/or unit of hardware that may be reprogrammed, such that, for instance, a data path between elements such as logic gates or other digital circuit elements may be modified to change an algorithm, state, logical sequence, or the like of the component and/or unit. This may be accomplished with such flexible high-speed computing fabrics as field-programmable gate arrays (FPGAs), which may include a grid of interconnected logic gates, connections between which may be severed and/or restored to program in modified logic.

Still referring to FIG. 8, reconfigurable hardware platform 816 may include a logic component 820. As used in this disclosure a “logic component” is a component that executes instructions on output language. For example, and without limitation, logic component may perform basic arithmetic, logic, controlling, input/output operations, and the like thereof. Logic component 820 may include any suitable processor, such as without limitation a component incorporating logical circuitry for performing arithmetic and logical operations, such as an arithmetic and logic unit (ALU), which may be regulated with a state machine and directed by operational inputs from memory and/or sensors; logic component 820 may be organized according to Von Neumann and/or Harvard architecture as a non-limiting example. Logic component 820 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), and/or system on a chip (SoC). In an embodiment, logic component 820 may include one or more integrated circuit microprocessors, which may contain one or more central processing units, central processors, and/or main processors, on a single metal-oxide-semiconductor chip. Logic component 820 may be configured to execute a sequence of stored instructions to be performed on the output language and/or intermediate representation 812. Logic component 820 may be configured to fetch and/or retrieve the instruction from a memory cache, wherein a “memory cache,” as used in this disclosure, is a stored instruction set on flight controller 804. Logic component 820 may be configured to decode the instruction retrieved from the memory cache to opcodes and/or operands. Logic component 820 may be configured to execute the instruction on intermediate representation 812 and/or output language. For example, and without limitation, logic component 820 may be configured to execute an addition operation on intermediate representation 812 and/or output language.

Still referring to FIG. 8, in an embodiment, logic component 820 may be configured to calculate a flight element 824. As used in this disclosure a “flight element” is an element of datum denoting a relative status of aircraft. For example, and without limitation, flight element 824 may denote one or more torques, thrusts, airspeed velocities, forces, altitudes, groundspeed velocities, directions during flight, directions facing, forces, orientations, and the like thereof. For example, and without limitation, flight element 824 may denote that aircraft is cruising at an altitude and/or with a sufficient magnitude of forward thrust. As a further non-limiting example, flight status may denote that is building thrust and/or groundspeed velocity in preparation for a takeoff. As a further non-limiting example, flight element 824 may denote that aircraft is following a flight path accurately and/or sufficiently.

Still referring to FIG. 8, flight controller 804 may include a chipset component 828. As used in this disclosure a “chipset component” is a component that manages data flow. In an embodiment, and without limitation, chipset component 828 may include a northbridge data flow path, wherein the northbridge dataflow path may manage data flow from logic component 820 to a high-speed device and/or component, such as a RAM, graphics controller, and the like thereof. In another embodiment, and without limitation, chipset component 828 may include a southbridge data flow path, wherein the southbridge dataflow path may manage data flow from logic component 820 to lower-speed peripheral buses, such as a peripheral component interconnect (PCI), industry standard architecture (ICA), and the like thereof. In an embodiment, and without limitation, southbridge data flow path may include managing data flow between peripheral connections such as ethernet, USB, audio devices, and the like thereof. Additionally or alternatively, chipset component 828 may manage data flow between logic component 820, memory cache, and a flight component 832. As used in this disclosure a “flight component” is a portion of an aircraft that can be moved or adjusted to affect one or more flight elements. For example, flight component 532 may include a component used to affect the aircrafts' roll and pitch which may comprise one or more ailerons. As a further example, flight component 832 may include a rudder to control yaw of an aircraft. In an embodiment, chipset component 828 may be configured to communicate with a plurality of flight components as a function of flight element 824. For example, and without limitation, chipset component 828 may transmit to an aircraft rotor to reduce torque of a first lift propulsor and increase the forward thrust produced by a pusher component to perform a flight maneuver.

Still referring to FIG. 8, in an embodiment 8, a remote device and/or FPGA may generate autonomous function as a function of an autonomous machine-learning model. As used in this disclosure a “remote device” is an external device to flight controller 804. As used in this disclosure an “autonomous function” is a mode and/or function of flight controller 804 that controls aircraft automatically. As used in this disclosure an “autonomous machine-learning model” is a machine-learning model to produce an autonomous function output given flight element 824 and a pilot signal 836 as inputs; this is in contrast to a non-machine learning software program where the commands to be executed are determined in advance by a user and written in a programming language. As used in this disclosure a “pilot signal” is an element of datum representing one or more functions a pilot is controlling and/or adjusting. For example, pilot signal 836 may denote that a pilot is controlling and/or maneuvering ailerons, wherein the pilot is not in control of the rudders and/or propulsors. In an embodiment, pilot signal 836 may include an implicit signal and/or an explicit signal. For example, and without limitation, pilot signal 836 may include an explicit signal, wherein the pilot explicitly states there is a lack of control and/or desire for autonomous function. As a further non-limiting example, pilot signal 836 may include an explicit signal directing flight controller 804 to control and/or maintain a portion of aircraft, a portion of the flight plan, the entire aircraft, and/or the entire flight plan. As a further non-limiting example, pilot signal 836 may include an implicit signal, wherein flight controller 804 detects a lack of control such as by a malfunction, torque alteration, flight path deviation, and the like thereof. In an embodiment, and without limitation, pilot signal 836 may include one or more explicit signals to reduce torque, and/or one or more implicit signals that torque may be reduced due to reduction of airspeed velocity. In an embodiment, and without limitation, pilot signal 836 may include one or more local and/or global signals. For example, and without limitation, pilot signal 836 may include a local signal that is transmitted by a pilot and/or crew member. As a further non-limiting example, pilot signal 836 may include a global signal that is transmitted by air traffic control and/or one or more remote users that are in communication with the pilot of aircraft. In an embodiment, pilot signal 836 may be received as a function of a tri-state bus and/or multiplexor that denotes an explicit pilot signal should be transmitted prior to any implicit or global pilot signal.

Still referring to FIG. 8, In some embodiments, autonomous function may perform one or more aircraft maneuvers, take offs, landings, altitude adjustments, flight leveling adjustments, turns, climbs, and/or descents. As a further non-limiting example, autonomous function may adjust one or more airspeed velocities, thrusts, torques, and/or groundspeed velocities. As a further non-limiting example, autonomous function may perform one or more flight path corrections and/or flight path modifications as a function of flight element 824. In an embodiment, autonomous function may include one or more modes of autonomy such as, but not limited to, autonomous mode, semi-autonomous mode, and/or non-autonomous mode. As used in this disclosure “autonomous mode” is a mode that automatically adjusts and/or controls aircraft and/or the maneuvers of aircraft in its entirety. For example, autonomous mode may denote that flight controller 804 will adjust the aircraft. As used in this disclosure a “semi-autonomous mode” is a mode that automatically adjusts and/or controls a portion and/or section of aircraft. For example, and without limitation, semi-autonomous mode may denote that a pilot will control the propulsors, wherein flight controller 804 will control the ailerons and/or rudders. As used in this disclosure “non-autonomous mode” is a mode that denotes a pilot will control aircraft and/or maneuvers of aircraft in its entirety.

Still referring to FIG. 8, autonomous machine-learning model may include one or more autonomous machine-learning processes such as supervised, unsupervised, or reinforcement machine-learning processes that flight controller 804 and/or a remote device may or may not use in the generation of autonomous function. Autonomous machine-learning process may include, without limitation machine learning processes such as simple linear regression, multiple linear regression, polynomial regression, support vector regression, ridge regression, lasso regression, elasticnet regression, decision tree regression, random forest regression, logistic regression, logistic classification, K-nearest neighbors, support vector machines, kernel support vector machines, naïve bayes, decision tree classification, random forest classification, K-means clustering, hierarchical clustering, dimensionality reduction, principal component analysis, linear discriminant analysis, kernel principal component analysis, Q-learning, State Action Reward State Action (SARSA), Deep-Q network, Markov decision processes, Deep Deterministic Policy Gradient (DDPG), or the like thereof.

Still referring to FIG. 8, in some embodiments, autonomous machine learning model may be trained as a function of autonomous training data, wherein autonomous training data may correlate a flight element, pilot signal, and/or simulation data to an autonomous function. For example, and without limitation, a flight element of an airspeed velocity, a pilot signal of limited and/or no control of propulsors, and a simulation data of required airspeed velocity to reach the destination may result in an autonomous function that includes a semi-autonomous mode to increase thrust of the propulsors. Autonomous training data may be received as a function of user-entered valuations of flight elements, pilot signals, simulation data, and/or autonomous functions. Autonomous training data may be received by one or more remote devices and/or FPGAs that at least correlate a flight element, pilot signal, and/or simulation data to an autonomous function. Autonomous training data may be received in the form of one or more user-entered correlations of a flight element, pilot signal, and/or simulation data to an autonomous function.

Still referring to FIG. 8, flight controller 804 may receive an autonomous function from a remote device and/or FPGA that utilizes one or more autonomous machine learning processes as described above. For example, and without limitation, a remote device may include a computing device, external device, processor, FPGA, microprocessor and the like thereof. Remote device and/or FPGA may perform the autonomous machine-learning process using autonomous training data to generate autonomous function and transmit the output to flight controller 804. Remote device and/or FPGA may transmit a signal, bit, datum, or parameter to flight controller 804 that at least relates to autonomous function. Additionally or alternatively, autonomous machine-learning model may include one or more autonomous machine-learning processes that a field-programmable gate array (FPGA) may or may not use in the generation of autonomous function. Additionally or alternatively, the remote device and/or FPGA may provide an updated machine-learning model. For example, and without limitation, an updated machine-learning model may be comprised of a firmware update, a software update, an autonomous machine-learning process correction, and the like thereof. As a non-limiting example a software update may incorporate a new simulation data that relates to a modified flight element. Additionally or alternatively, the updated machine learning model may be transmitted to the remote device and/or FPGA, wherein the remote device and/or FPGA may replace the autonomous machine-learning model with the updated machine-learning model and generate the autonomous function as a function of the flight element, pilot signal, and/or simulation data using the updated machine-learning model. The updated machine-learning model may be transmitted by the remote device and/or FPGA and received by flight controller 804 as a software update, firmware update, or corrected autonomous machine-learning model. For example, and without limitation autonomous machine learning model may utilize a neural net machine-learning process, wherein the updated machine-learning model may incorporate a gradient boosting machine-learning process.

Still referring to FIG. 8, flight controller 804 may include, be included in, and/or communicate with a mobile device such as a mobile telephone or smartphone. Further, flight controller may communicate with one or more additional devices as described below in further detail via a network interface device. The network interface device may be utilized for commutatively connecting a flight controller to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. The network may include any network topology and can may employ a wired and/or a wireless mode of communication.

Still referring to FIG. 8, in an embodiment, 8flight controller 804 may include, but is not limited to, for example, a cluster of flight controllers in a first location and a second flight controller or cluster of flight controllers in a second location. Flight controller 804 may include one or more flight controllers dedicated to data storage, security, distribution of traffic for load balancing, and the like. Flight controller 804 may be configured to distribute one or more computing tasks as described below across a plurality of flight controllers, which may operate in parallel, in series, redundantly, or in any other manner used for distribution of tasks or memory between computing devices. For example, and without limitation, flight controller 804 may implement a control algorithm to distribute and/or command the plurality of flight controllers. As used in this disclosure a “control algorithm” is a finite sequence of well-defined computer implementable instructions that may determine the flight component of the plurality of flight components to be adjusted. For example, and without limitation, control algorithm may include one or more algorithms that reduce and/or prevent aviation asymmetry. As a further non-limiting example, control algorithms may include one or more models generated as a function of a software including, but not limited to Simulink by MathWorks, Natick, Massachusetts, USA. In an embodiment, and without limitation, control algorithm may be configured to generate an auto-code, wherein an “auto-code,” is used herein, is a code and/or algorithm that is generated as a function of the one or more models and/or software's. In another embodiment, control algorithm may be configured to produce a segmented control algorithm. As used in this disclosure a “segmented control algorithm” is control algorithm that has been separated and/or parsed into discrete sections. For example, and without limitation, segmented control algorithm may parse control algorithm into two or more segments, wherein each segment of control algorithm may be performed by one or more flight controllers operating on distinct flight components.

Still referring to FIG. 8, in an embodiment, 8control algorithm may be configured to determine a segmentation boundary as a function of segmented control algorithm. As used in this disclosure a “segmentation boundary” is a limit and/or delineation associated with the segments of the segmented control algorithm. For example, and without limitation, segmentation boundary may denote that a segment in the control algorithm has a first starting section and/or a first ending section. As a further non-limiting example, segmentation boundary may include one or more boundaries associated with an ability of flight component 832. In an embodiment, control algorithm may be configured to create an optimized signal communication as a function of segmentation boundary. For example, and without limitation, optimized signal communication may include identifying the discrete timing required to transmit and/or receive the one or more segmentation boundaries. In an embodiment, and without limitation, creating optimized signal communication further comprises separating a plurality of signal codes across the plurality of flight controllers. For example, and without limitation the plurality of flight controllers may include one or more formal networks, wherein formal networks transmit data along an authority chain and/or are limited to task-related communications. As a further non-limiting example, communication network may include informal networks, wherein informal networks transmit data in any direction. In an embodiment, and without limitation, the plurality of flight controllers may include a chain path, wherein a “chain path,” as used herein, is a linear communication path comprising a hierarchy that data may flow through. In an embodiment, and without limitation, the plurality of flight controllers may include an all-channel path, wherein an “all-channel path,” as used herein, is a communication path that is not restricted to a particular direction. For example, and without limitation, data may be transmitted upward, downward, laterally, and the like thereof. In an embodiment, and without limitation, the plurality of flight controllers may include one or more neural networks that assign a weighted value to a transmitted datum. For example, and without limitation, a weighted value may be assigned as a function of one or more signals denoting that a flight component is malfunctioning and/or in a failure state.

Still referring to FIG. 8, the plurality of flight controllers may include a master bus controller. As used in this disclosure a “master bus controller” is one or more devices and/or components that are connected to a bus to initiate a direct memory access transaction, wherein a bus is one or more terminals in a bus architecture. Master bus controller may communicate using synchronous and/or asynchronous bus control protocols. In an embodiment, master bus controller may include flight controller 804. In another embodiment, master bus controller may include one or more universal asynchronous receiver-transmitters (UART). For example, and without limitation, master bus controller may include one or more bus architectures that allow a bus to initiate a direct memory access transaction from one or more buses in the bus architectures. As a further non-limiting example, master bus controller may include one or more peripheral devices and/or components to communicate with another peripheral device and/or component and/or the master bus controller. In an embodiment, master bus controller may be configured to perform bus arbitration. As used in this disclosure “bus arbitration” is method and/or scheme to prevent multiple buses from attempting to communicate with and/or connect to master bus controller. For example and without limitation, bus arbitration may include one or more schemes such as a small computer interface system, wherein a small computer interface system is a set of standards for physical connecting and transferring data between peripheral devices and master bus controller by defining commands, protocols, electrical, optical, and/or logical interfaces. In an embodiment, master bus controller may receive intermediate representation 812 and/or output language from logic component 820, wherein output language may include one or more analog-to-digital conversions, low bit rate transmissions, message encryptions, digital signals, binary signals, logic signals, analog signals, and the like thereof described above in detail.

Still referring to FIG. 8, master bus controller may communicate with a slave bus. As used in this disclosure a “slave bus” is one or more peripheral devices and/or components that initiate a bus transfer. For example, and without limitation, slave bus may receive one or more controls and/or asymmetric communications from master bus controller, wherein slave bus transfers data stored to master bus controller. In an embodiment, and without limitation, slave bus may include one or more internal buses, such as but not limited to a/an internal data bus, memory bus, system bus, front-side bus, and the like thereof. In another embodiment, and without limitation, slave bus may include one or more external buses such as external flight controllers, external computers, remote devices, printers, aircraft computer systems, flight control systems, and the like thereof.

Still referring to FIG. 8, in an embodiment, 8 control algorithm may optimize signal communication as a function of determining one or more discrete timings. For example, and without limitation master bus controller may synchronize timing of the segmented control algorithm by injecting high priority timing signals on a bus of the master bus control. As used in this disclosure a “high priority timing signal” is information denoting that the information is important. For example, and without limitation, high priority timing signal may denote that a section of control algorithm is of high priority and should be analyzed and/or transmitted prior to any other sections being analyzed and/or transmitted. In an embodiment, high priority timing signal may include one or more priority packets. As used in this disclosure a “priority packet” is a formatted unit of data that is communicated between the plurality of flight controllers. For example, and without limitation, priority packet may denote that a section of control algorithm should be used and/or is of greater priority than other sections.

Still referring to FIG. 8, flight controller 804 may also be implemented using a “shared nothing” architecture in which data is cached at the worker, in an embodiment, this may enable scalability of aircraft and/or computing device. Flight controller 804 may include a distributer flight controller. As used in this disclosure a “distributer flight controller” is a component that adjusts and/or controls a plurality of flight components as a function of a plurality of flight controllers. For example, distributer flight controller may include a flight controller that communicates with a plurality of additional flight controllers and/or clusters of flight controllers.

Still referring to FIG. 8, flight controller may include a sub-controller 840. As used in this disclosure a “sub-controller” is a controller and/or component that is part of a distributed controller as described above; for instance, flight controller 804 may be and/or include a distributed flight controller made up of one or more sub-controllers. For example, and without limitation, sub-controller 840 may include any controllers and/or components thereof that are similar to distributed flight controller and/or flight controller as described above. Sub-controller 840 may include any component of any flight controller as described above. Sub-controller 840 may be implemented in any manner suitable for implementation of a flight controller as described above. As a further non-limiting example, sub-controller 840 may include one or more processors, logic components and/or computing devices capable of receiving, processing, and/or transmitting data across the distributed flight controller as described above. As a further non-limiting example, sub-controller 840 may include a controller that receives a signal from a first flight controller and/or first distributed flight controller component and transmits the signal to a plurality of additional sub-controllers and/or flight components.

Still referring to FIG. 8, flight controller may include a co-controller 844. As used in this disclosure a “co-controller” is a controller and/or component that joins flight controller 804 as components and/or nodes of a distributer flight controller as described above. For example, and without limitation, co-controller 844 may include one or more controllers and/or components that are similar to flight controller 804. As a further non-limiting example, co-controller 844 may include any controller and/or component that joins flight controller 804 to distributer flight controller. As a further non-limiting example, co-controller 844 may include one or more processors, logic components and/or computing devices capable of receiving, processing, and/or transmitting data to and/or from flight controller 804 to distributed flight control system. Co-controller 844 may include any component of any flight controller as described above. Co-controller 844 may be implemented in any manner suitable for implementation of a flight controller as described above.

Still referring to FIG. 8, in an embodiment, 8flight controller 804 may be designed and/or configured to perform any method, method step, or sequence of method steps in any embodiment described in this disclosure, in any order and with any degree of repetition. For instance, flight controller 804 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Flight controller may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

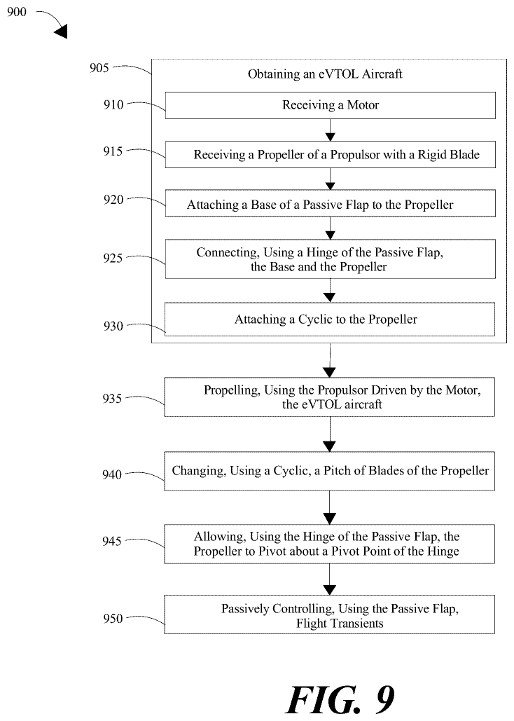

Now referring to FIG. 9, a method 900 of a combined cyclic and teeter system of an electric vertical takeoff and landing aircraft is shown. In some embodiments, method 905 includes a step 905 of obtaining an eVTOL aircraft. In some embodiments, method 905 includes a step 910 of receiving a motor. In some embodiments, method 905 includes a step 915 of receiving a propeller of a propulsor, wherein the propeller may include a rigid blade. In some embodiments, the propeller may include a hub, wherein a cyclic and a passive flap are each attached to the hub. In some embodiments, method 905 includes a step 920 of attaching a base of the passive flap to the propulsor. In some embodiments, method 905 includes a step 925 of connecting, using a hinge of the passive flap, the base and the propeller. In some embodiments, method 905 includes a step 930 of attaching a cyclic to the propeller.

Still referring to FIG. 0, in some embodiments, method 900 includes a step 935 of propelling, using a propulsor driven by the motor, an eVTOL aircraft. In some embodiments, the propulsor may be a lift propulsor. This may be implemented as disclosed with respect to FIG. 1-8.

Still referring to FIG. 9, in some embodiments, method 900 may include step 940 of changing, using a cyclic, a pitch of blades of a propeller. In some embodiments, method 900 may further include controlling, using the cyclic, steady loads from edgewise flight. In some embodiments, the steady loads are anticipated by a flight speed. In some embodiments, method 900 includes a step 945 of allowing, using the hinge of the passive flap, the propeller to pivot about a pivot point of the hinge. In some embodiments, method 900 includes a step 950 of passively controlling, using the passive flap attached to the propulsor, flight transients. In some embodiments, the flight transients may include wind gusts. In some embodiments, the passive flap may passively control the flight transients while the cyclic controls steady loads from the edgewise flight. This may be implemented as disclosed with respect to FIG. 1-8.

Still referring to FIG. 9, in some embodiments, the eVTOL aircraft may further include a cyclic control, wherein the cyclic control is positioned in a fuselage of the eVTOL aircraft. In some embodiments, the cyclic control does not include a collective control, wherein the collective control is configured to change the pitch of the blades of the propeller all at the same time. In some embodiments, the eVTOL aircraft may further include a flight controller communicatively connected with the motor and the cyclic, further comprising adjusting, using the flight controller, the pitch of the blades of the propeller as a function of the cyclic control. This may be implemented as disclosed with respect to FIG. 1-8.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

FIG. 10 shows a diagrammatic representation of one embodiment of a computing device in the exemplary form of a computer system 1000 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 1000 includes a processor 1004 and a memory 1008 that communicate with each other, and with other components, via a bus 1012. Bus 1012 may include any of several types of bus structures including, but not limited to, a memory bus, a memory controller, a peripheral bus, a local bus, and any combinations thereof, using any of a variety of bus architectures.

Processor 1004 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 1004 may be organized according to Von Neumann and/or Harvard architecture as a non-limiting example. Processor 1004 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), and/or system on a chip (SoC).

Memory 1008 may include various components (e.g., machine-readable media) including, but not limited to, a random-access memory component, a read only component, and any combinations thereof. In one example, a basic input/output system 1016 (BIOS), including basic routines that help to transfer information between elements within computer system 1000, such as during start-up, may be stored in memory 1008. Memory 1008 may also include (e.g., stored on one or more machine-readable media) instructions (e.g., software) 1020 embodying any one or more of the aspects and/or methodologies of the present disclosure. In another example, memory 1008 may further include any number of program modules including, but not limited to, an operating system, one or more application programs, other program modules, program data, and any combinations thereof.

Computer system 1000 may also include a storage device 1024. Examples of a storage device (e.g., storage device 1024) include, but are not limited to, a hard disk drive, a magnetic disk drive, an optical disc drive in combination with an optical medium, a solid-state memory device, and any combinations thereof. Storage device 1024 may be connected to bus 1012 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 1024 (or one or more components thereof) may be removably interfaced with computer system 1000 (e.g., via an external port connector (not shown)). Particularly, storage device 1024 and an associated machine-readable medium 1028 may provide nonvolatile and/or volatile storage of machine-readable instructions, data structures, program modules, and/or other data for computer system 1000. In one example, software 1020 may reside, completely or partially, within machine-readable medium 1028. In another example, software 1020 may reside, completely or partially, within processor 1004.

Computer system 1000 may also include an input device 1032. In one example, a user of computer system 1000 may enter commands and/or other information into computer system 1000 via input device 1032. Examples of an input device 1032 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 1032 may be interfaced to bus 1012 via any of a variety of interfaces (not shown) including, but not limited to, a serial interface, a parallel interface, a game port, a USB interface, a FIREWIRE interface, a direct interface to bus 1012, and any combinations thereof. Input device 1032 may include a touch screen interface that may be a part of or separate from display 1036, discussed further below. Input device 1032 may be utilized as a user selection device for selecting one or more graphical representations in a graphical interface as described above.

A user may also input commands and/or other information to computer system 1000 via storage device 1024 (e.g., a removable disk drive, a flash drive, etc.) and/or network interface device 1040. A network interface device, such as network interface device 1040, may be utilized for connecting computer system 1000 to one or more of a variety of networks, such as network 1044, and one or more remote devices 1048 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 1044, may employ a wired and/or a wireless mode of communication. In general, any network topology may be used. Information (e.g., data, software 1020, etc.) may be communicated to and/or from computer system 1000 via network interface device 1040.

Computer system 1000 may further include a video display adapter 1052 for communicating a displayable image to a display device, such as display device 1036. Examples of a display device include, but are not limited to, a liquid crystal display (LCD), a cathode ray tube (CRT), a plasma display, a light emitting diode (LED) display, and any combinations thereof. Display adapter 1052 and display device 1036 may be utilized in combination with processor 1004 to provide graphical representations of aspects of the present disclosure. In addition to a display device, computer system 1000 may include one or more other peripheral output devices including, but not limited to, an audio speaker, a printer, and any combinations thereof. Such peripheral output devices may be connected to bus 1012 via a peripheral interface 1056. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions, and additions may be made to that which is specifically disclosed herein without departing from the spirit and scope of the present invention.

What is claimed is:

1. A combined cyclic and teeter system for an electric vertical takeoff and landing (eVTOL) aircraft, wherein the system comprising:
an eVTOL aircraft, wherein the eVTOL aircraft comprises:
a motor;
a propulsor driven by the motor, wherein the propulsor comprises a propeller with a rigid blade and configured to propel the eVTOL aircraft;
a cyclic attached to the propeller and configured to change a pitch of blades of the propeller; and
a passive flap attached to the propeller and configured to passively control flight transients, wherein the passive flap comprises:
a base rotatably affixed to the propulsor and configured to rotate about a rotational axis; and
a hinge connecting the base and the propeller and configured to allow the propeller to pivot about a pivot point of the hinge.

2. The system of claim 1, wherein the eVTOL aircraft further comprises a cyclic control, wherein the cyclic control is positioned in a fuselage of the eVTOL aircraft.

3. The system of claim 2, wherein:
the eVTOL aircraft does not comprise a collective control; and
the propulsor is a monolithic component.

4. The system of claim 2, wherein the eVTOL aircraft further comprises a flight controller communicatively connected with the motor and the cyclic, wherein the flight controller is configured to adjust the pitch of the blades of the propeller as a function of the cyclic control.

5. The system of claim 1, wherein the propulsor comprises a lift propulsor.

6. The system of claim 1, wherein the flight transients comprise wind gusts.

7. The system of claim 1, wherein the propeller comprises a hub, wherein the cyclic and the passive flap are each attached to the hub.

8. The system of claim 1, wherein the cyclic is further configured to control steady loads from edgewise flight.

9. The system of claim 8, wherein the steady loads are anticipated by a flight speed.

10. The system of claim 8, wherein the passive flap passively controls the flight transients while the cyclic controls steady loads from the edgewise flight.

11. A method of a combined cyclic and teeter system of eVTOL aircraft, wherein the method comprises:
obtaining an eVTOL aircraft, comprising:
receiving a motor;
receiving a propeller of a propulsor, wherein the propeller comprises a rigid blade;
attaching a base of a passive flap to the propeller;
connecting, using a hinge of the passive flap, the base and the propeller;
attaching a cyclic to the propeller;
propelling, using the propulsor driven by the motor, the eVTOL aircraft;
changing, using the cyclic, a pitch of blades of the propeller;
allowing, using the hinge of the passive flap, the propeller to pivot about a pivot point of the hinge; and
passively controlling, using the passive flap, flight transients.

12. The method of claim 11, wherein the eVTOL aircraft further comprises a cyclic control, wherein the cyclic control is positioned in a fuselage of the eVTOL aircraft.

13. The method of claim 12, wherein:
the eVTOL aircraft does not comprise a collective control; and
the propulsor is a monolithic component.

14. The method of claim 12, wherein the eVTOL aircraft further comprises a flight controller communicatively connected with the motor and the cyclic, further comprising:
adjusting, using the flight controller, the pitch of the blades of the propeller as a function of the cyclic control.

15. The method of claim 11, wherein the propulsor comprises a lift propulsor.

16. The method of claim 11, wherein the flight transients comprise wind gusts.

17. The method of claim 11, wherein the propeller comprises a hub, wherein the cyclic and the passive flap are each attached to the hub.

18. The method of claim 11, further comprising:
controlling, using the cyclic, steady loads from edgewise flight.

19. The method of claim 17, wherein the steady loads are anticipated by a flight speed.

20. The method of claim 17, wherein the passive flap passively controls the edgewise flight transients while the cyclic controls steady loads from the flight.
